(19) United States
(12) Patent Application Publication
(10) Pub. No.: US 2024/0253592 A1
(43) Pub. Date: Aug. 1, 2024

(54) COMPONENT FOR VEHICLE INTERIOR

(71) Applicant: Yanfeng International Automotive Technology Co., Ltd., Shanghai (CN)

(72) Inventors: Wei ZHAO, Shanghai (CN); Xudong DU, Shanghai (CN); Yongliang HUANG, Shanghai (CN); Jian SHAO, Shanghai (CN)

(73) Assignee: Yanfeng International Automotive Technology Co., Ltd., Shanghai (CN)

(21) Appl. No.: 18/565,812

(22) PCT Filed: Sep. 26, 2022
(86) PCT No.: PCT/CN2022/121295

§ 371 Date: Nov. 30, 2023

(30) Foreign Application Priority Data
Sep. 29, 2021 (CN) 202111149628.4
Sep. 29, 2021 (CN) 202111149811.4
Sep. 29, 2021 (CN) 202122384113.4

(51) Int. Cl. B60R 22/46

(52) U.S. Cl. CPC B60R 22/4619; B60R 2022/4666; B60R 2022/468

(57) ABSTRACT

A seatbelt retractor for a vehicle interior is disclosed. The retractor may comprise a spool to pretension a belt, a motor, a transmission and a one-way clutch to pretension the belt when the motor drives the spool via the transmission. The one-way clutch may comprise a drive gear rotatable in a first direction to retract the belt and a second direction opposite to the first direction, a driven gear comprising a common axis of rotation with the drive gear, a set of pawls pivotably mounted on the drive gear, and a friction ring frictionally coupled with a stop ring. The drive gear may rotate relative to the friction ring. When the drive gear is in a first position, the set of pawls may be disengaged from the driven gear. When the drive gear is in a second position, the pawls may be engaged with the driven gear.

### CROSS-REFERENCE TO RELATED APPLICATIONS

The present application claims priority to and incorporates by reference in full the following patent applications (a) Chinese Patent Application No. 202111149628.4 filed Sep. 29, 2021; (b) Chinese Patent Application No. 202111149811.4 filed Sep. 29, 2021; (c) Chinese Utility Model Application No. 202122384113.4 filed Sep. 29, 2021 (now Chinese Utility Model No. 215805886U).

### FIELD

The present invention relates to a component for a vehicle interior.

The present invention also relates to a one-way clutch and seatbelt retractor.

### BACKGROUND

It is known to provide a seatbelt retractor with a clutch mechanism.

It would be advantageous to provide an improved seatbelt retractor with a one-way clutch mechanism.

### SUMMARY

The present invention relates to a seatbelt retractor for a vehicle interior comprising a belt; a belt retraction spool configured to pretension the belt; a motor; a transmission coupled to the motor; and a one-way clutch coupled to the transmission. The one-way clutch may be configured for a disengaged state and an engaged state to pretension the belt. When the one-way clutch is in the engaged state, the motor may be configured to drive the belt retraction spool via the transmission device and the one-way clutch to pretension the belt. The one-way clutch may comprise a drive gear and a driven gear. The drive gear may be configured to rotate in a first direction to retract the belt and a second direction opposite to the first direction. The drive gear and the driven gear may comprise a common axis of rotation. The one-way clutch may comprise a set of pawls pivotably mounted on the drive gear. The one-way clutch may comprise a friction ring frictionally coupled with a stop ring. The drive gear may be configured to rotate relative to the friction ring between a first rotational position and a second rotational position. When the drive gear is in the first rotational position, the set of pawls is in a first pivot position disengaged from the driven gear. When the drive gear is in the second rotational position, the pawls may be in a second pivot position engaged with the driven gear. Each pawl of the set of pawls may comprise a locking component configured to lock with the drive gear. The locking component may be injection-molded onto a body of the pawl. The locking component may be configured to may protrude from a body of a pawl of the set of pawls in a direction away from a free end portion of the pawl. Each pawl of the set of pawls may comprise a free end portion remote from a pivot axis parallel to the rotation axis; the free end portion may be configured for cooperation with the driven gear. The locking component may comprise an elastic component; a pawl of the set of pawls may be configured to abut against the drive gear through the locking component. The locking component may comprise a hook portion configured to be hooked by the drive gear. The drive gear may comprise a projection comprising an engaging hook portion. A pawl of the set of pawls may be configured to abut against a surface of the projection of the drive gear adjacent to the engaging hook portion through the hook portion in the first pivot position. The hook portion may be configured to slide on the projection to hook the engaging hook portion. The second pivot position may be pivoted radially inward from the first pivot position. A pawl of the set of pawls may comprise a sliding surface. The friction ring may comprise a guiding member configured to guide the sliding surface. When the drive gear rotates relative to the friction ring between the first rotational position and the second rotational position, the pawl may be configured to pivot relative to the drive gear between the first pivot position and the second pivot position through cooperation of the guiding member and the sliding surface. Each pawl may comprise a free end portion adjacent the sliding surface; the free end portion may be configured for cooperation with the driven gear. The sliding surface may protrude axially from a body of a pawl of the set of pawls. The set of pawls may comprise two pawls; the pivot axes of the two pawls may be aligned with one another. The two pawls may each comprise sliding surfaces. The friction ring may comprise a pair of guiding members configured to guide the sliding surfaces on two sides of the sliding surfaces. The pair of guiding members may comprise contact portions opposite to each other. The sliding surfaces may be guided between the contact portions. Each contact portion of the contact portions may comprise a cylindrical surface. A first guiding member of the pair of guiding members may comprise a first portion protruding inwardly from a ring body of the friction ring, a second portion bent relative to the first portion at a radially inner end portion of the first portion, and a third portion protruding axially from the second portion; the third portion may comprise a cylindrical body comprising a cylindrical surface. A second guiding member of the pair of guiding members may comprise an arm protruding inwardly from the ring body of the friction ring, and a free end portion of the arm, as the contact portion, may comprise a cylindrical surface. The third portion may be radially inward of the free end portion of the arm with reference to the rotation axis. The third portion and the free end portion of the arm may have the same angular position in a circumferential direction or may have an angular spacing. The friction ring may be mounted radially inward of the stop ring; an outer circumferential surface of the friction ring may be frictionally coupled with an inner circumferential surface of the stop ring. The drive gear and the friction ring may each comprise a first cam. The first cam of the drive gear and the first cam of the friction ring may be configured to define the first rotational position. The drive gear and the friction ring may each comprise a second cam. The second cam of the drive gear and the second cam of the friction ring may be configured to define the second rotational position. A contact surface of the first cam of the drive gear and the first cam of the friction ring may deviate from a radial plane with reference to the rotation axis. The stop ring (a) may comprise a stator or (b) may be configured for limited rotation. The drive gear may comprise a chamber comprising a bottom on one axial end side of the drive gear. The chamber may be open on the other axial end side of the drive gear. The stop ring, the friction ring and the pawls may be accommodated in the chamber. An axial stop disk connected with the drive gear may be mounted on the other opened axial end side. The driven gear may be configured to enter the chamber by passing through an opening of the bottom. A portion of the pawl may occupy an angular area of not more than 60 degrees from the pivot axes to the free end portions in the first pivot position and/or in the second pivot position with reference to the rotation axis. Each pawl of the set of pawls may comprise a locking component configured to lock with the drive gear in a pass-through position for the pawl passing through the first pivot position in a radially-outward pivot direction when the pawl passes through the first pivot position in the radially-outward pivot direction. The locking component may comprise an elastic component. In the first pivot position, a pawl of the set of pawls may abut against the drive gear through the locking component. Each locking component may comprise a hook portion configured to be hooked by the drive gear when the pawl passes through the first pivot position in the radially-outward pivot direction such that the pawl is held in the pass-through position. The drive gear may comprise projections comprising engaging hook portions. Each pawl of the set of pawls may abut against a surface of a projection adjacent to the engaging hook portion through the hook portion in the first pivot position. The hook portion may be configured to slide on the projection when the pawl pivots relative to the drive gear from the first pivot position towards the pass-through position such that the hook portion hooks the engaging hook portion. The locking component may be injection-molded onto a body of a pawl of the set of pawls. The locking component may protrude from a body of a pawl of the set of pawls in a direction away from a free end portion of the pawl. The friction ring may comprise elastic components. The elastic components of the friction ring may be configured to press the set of pawls and counteract the set of pawls leaving the first pivot position in a radially-inward pivot direction in the first pivot position of the set of pawls relative to the drive gear. The elastic components of the friction ring may be out of contact with the set of pawls upon a predetermined stroke of the set of pawls away from the first pivot position in the radially-inward pivot direction. The elastic components of the friction ring may be finger-shaped elements injection-molded onto a ring body of the friction ring. The seatbelt retractor may be configured for assembly to a belt pre-tensioner.

The present invention relates to a one-way clutch comprising a driving element rotatable in a first direction and a second direction opposite to the first direction; a driven element having a common rotation axis with the driving element; pawls pivotably mounted on the driving element; a stop ring; and a friction ring frictionally coupled with the stop ring. The driving element may be rotatable relative to the friction ring between a first rotational position and a second rotational position downstream of the first rotational position in the first direction. In the first rotational position, the pawls are in a first pivot position relative to the driving element. In the first pivot position, the pawls are disengaged from the driven element. In the second rotational position, the pawls are in a second pivot position relative to the driving element pivoted radially inward from the first pivot position. In the second pivot position, the pawls are engaged with the driven element. Each pawl may comprise a sliding surface. The friction ring may comprise guiding members for guiding the sliding surfaces on both sides of the sliding surfaces, and the pawls are pivotable relative to the driving element between the first pivot position and the second pivot position through cooperation of the guiding members and the sliding surfaces when the driving element rotates relative to the friction ring between the first rotational position and the second rotational position. Each pawl may comprise a free end portion remote from a pivot axis parallel to the rotation axis. The free end portion may be configured for cooperation with the driven element. The sliding surfaces may protrude axially from bodies of the pawls with reference to the pivot axes of the pawls. The one-way clutch may comprise two pawls, and the pivot axes of the two pawls may be on one diameter line with reference to the rotation axis. The friction ring may comprise a pair of guiding members for guiding the sliding surfaces on both sides of the sliding surfaces, the pair of guiding members may comprise contact portions opposite to each other, and the sliding surfaces are guided between the contact portions. Each contact portion may comprise a cylindrical surface. Each first guiding member of the pair of guiding members may comprise a first portion protruding inwardly from a ring body of the friction ring, a second portion bent relative to the first portion at a radially inner end portion of the first portion, and a third portion protruding axially from the second portion, the third portion, as the contact portion, being configured as a cylindrical body having a cylindrical surface; and/or each second guiding member of the pair of guiding members may comprise an arm protruding inwardly from the ring body of the friction ring, and a free end portion of the arm, as the contact portion, has a cylindrical surface. The third portion is radially inward of the free end portion of the arm with reference to the rotation axis, and/or the third portion and the free end portion of the arm may have the same angular position in a circumferential direction or may have an angular spacing. The friction ring is mounted radially inward of the stop ring, and an outer circumferential surface of the friction ring is frictionally coupled with an inner circumferential surface of the stop ring. The driving element and the friction ring may each comprise a first cam. The first cams may be configured for defining the first rotational position where the driving element and the friction ring are relative to each other. The driving element and the friction ring may each comprise a second cam. The second cams may be configured for defining the second rotational position where the driving element and the friction ring are relative to each other. A contact surface of the first cam of the driving element and the first cam of the friction ring may deviate from a radial plane with reference to the rotation axis. The stop ring may comprise a stator. The stop ring may be configured for limited rotation. The driving element may comprise a chamber having a bottom on one axial end side of the driving element and being open on the other axial end side of the driving element. The stop ring, the friction ring and the pawls may be accommodated in the chamber. An axial stop disk connected with the driving element may be mounted on the other opened axial end side. The driven element may be configured to enter the chamber by passing through an opening of the bottom. Portions of the pawls from the pivot axes to the free end portions may occupy an angular area of not more than 60 degrees in the first pivot position and/or in the second pivot position with reference to the rotation axis. Each pawl may comprise a locking component configured to lock with the driving element in a pass-through position for the pawl passing through the first pivot position in a radially-outward pivot direction when the pawl passes through the first pivot position in the radially-outward pivot direction. The locking components may comprise elastic components. In the first pivot position, the pawls may abut against the driving element through the locking components. Each locking component may comprise a hook portion configured to be hooked by the driving element when the pawl passes through the first pivot position in the radially-outward pivot direction such that the pawl is held in the pass-through position. The locking components may be injection-molded onto bodies of the pawls. The locking components may protrude from bodies of the pawls in a direction away from the free end portions of the pawls. The driving element may comprise projections having engaging hook portions. Each pawl may abut against a surface of the projection adjacent to the engaging hook portion through the hook portion in the first pivot position. The hook portion may slide on the projection when the pawl pivots relative to the driving element from the first pivot position towards the pass-through position such that the hook portion hooks the engaging hook portion. The friction ring may comprise elastic components. The elastic components of the friction ring may press the pawls and counteract the pawls leaving the first pivot position in a radially-inward pivot direction in the first pivot position of the pawls relative to the driving element. The elastic components of the friction ring may be out of contact with the pawls upon a predetermined stroke of the pawls away from the first pivot position in the radially-inward pivot direction. The elastic components of the friction ring may comprise finger-shaped elements injection-molded onto a ring body of the friction ring. The driving element and the driven element may comprise gears. A seatbelt retractor may comprise a belt retraction spool, a driving device and the one-way clutch. The driving device may be connected with a driving element of the one-way clutch in a transmission manner. The belt retraction spool may be connected with a driven element of the one-way clutch in a transmission manner.

The present invention relates to a one-way clutch comprising a driving element rotatable in a first direction and a second direction opposite to the first direction; a driven element having a common rotation axis with the driving element; pawls pivotably mounted on the driving element; a stop ring; and a friction ring frictionally coupled with the stop ring. The driving element is rotatable relative to the friction ring between a first rotational position and a second rotational position downstream of the first rotational position in the first direction. In the first rotational position, the pawls are in a first pivot position relative to the driving element. In the first pivot position, the pawls are disengaged from the driven element. In the second rotational position, the pawls are in a second pivot position relative to the driving element pivoted radially inward from the first pivot position. In the second pivot position, the pawls are engaged with the driven element. Each pawl may comprise a locking component configured to lock with the driving element in a pass-through position for the pawl passing through the first pivot position in a radially-outward pivot direction when the pawl passes through the first pivot position in the radially-outward pivot direction. The locking components may comprise elastic components. In the first pivot position, the pawls may abut against the driving element through the locking components. Each locking component may comprise a hook portion configured to be hooked by the driving element when the pawl passes through the first pivot position in the radially-outward pivot direction such that the pawl is held in the pass-through position. The driving element may comprise projections having engaging hook portions. Each pawl may abut against a surface of the projection adjacent to the engaging hook portion through the hook portion in the first pivot position. The hook portion may be configured to slide on the projection when the pawl pivots relative to the driving element from the first pivot position towards the pass-through position such that the hook portion hooks the engaging hook portion. The locking components may be injection-molded onto bodies of the pawls. The locking components may protrude from bodies of the pawls in a direction away from free end portions of the pawls. Each pawl may comprise a free end portion remote from a pivot axis parallel to the rotation axis. The free end portion may be configured for cooperation with the driven element.

The present invention relates to a seatbelt retractor comprising a belt retraction spool, a driving device and a one-way clutch. The driving device may be connected with a driving element of the one-way clutch in a transmission manner, and the belt retraction spool may be connected with a driven element of the one-way clutch in a transmission manner. The driving element may be configured to rotate in a first direction and a second direction opposite to the first direction. The driven element may have a common rotation axis with the driving element. The one-way clutch may comprise pawls pivotably mounted on the driving element, a stop ring, and a friction ring frictionally coupled with the stop ring. The driving element may be configured to rotate relative to the friction ring between a first rotational position and a second rotational position downstream of the first rotational position in the first direction. In the first rotational position, the pawls may be in a first pivot position relative to the driving element, and in the first pivot position, the pawls may be disengaged from the driven element. In the second rotational position, the pawls may be in a second pivot position relative to the driving element pivoted radially inward from the first pivot position, and in the second pivot position, the pawls may be engaged with the driven element. Each pawl may comprise a locking component configured to lock with the driving element in a pass-through position for the pawl passing through the first pivot position in a radially-outward pivot direction when the pawl passes through the first pivot position in the radially-outward pivot direction. The locking components may comprise elastic components, and in the first pivot position, the pawls may abut against the driving element through the locking components. Each locking component may comprise a hook portion configured to be hooked by the driving element when the pawl passes through the first pivot position in the radially-outward pivot direction, such that the pawl is held in the pass-through position. The driving element may comprise projections comprising engaging hook portions. Each pawl may abut against a surface of the projection adjacent to the engaging hook portion through the hook portion in the first pivot position, and the hook portion may slide on the projection when the pawl pivots relative to the driving element from the first pivot position towards the pass-through position, such that the hook portion may hook the engaging hook portion. The locking components may be injection-molded onto bodies of the pawls. The locking components may protrude from bodies of the pawls in a direction away from the free end portions of the pawls. Each pawl may comprise a free end portion remote from a pivot axis parallel to the rotation axis. The free end portion may be configured for cooperation with the driven element. Each pawl may comprise a sliding surface. The friction ring may comprise guiding members configured to guide the sliding surfaces. The pawls may be configured to pivot relative to the driving element between the first pivot position and the second pivot position through cooperation of the guiding members and the sliding surfaces when the driving element rotates relative to the friction ring between the first rotational position and the second rotational position. The sliding surfaces may protrude axially from bodies of the pawls with reference to the pivot axes of the pawls. The one-way clutch may comprise two pawls, and the pivot axes of the two pawls may be on one diameter line with reference to the rotation axis. The friction ring may comprise a pair of guiding members configured to guide the sliding surfaces on both sides of the sliding surfaces. The pair of guiding members may comprise contact portions opposite to each other, and the sliding surfaces may be guided between the contact portions. Each contact portion may comprise a cylindrical surface. Each first guiding member of the pair of guiding members may comprise a first portion protruding inwardly from a ring body of the friction ring, a second portion bent relative to the first portion at a radially inner end portion of the first portion, and a third portion protruding axially from the second portion, the third portion, as the contact portion, configured as a cylindrical body comprising a cylindrical surface. Each second guiding member of the pair of guiding members may comprise an arm protruding inwardly from the ring body of the friction ring, and a free end portion of the arm, as the contact portion, comprising a cylindrical surface. The third portion may be radially inward of the free end portion of the arm with reference to the rotation axis. The third portion and the free end portion of the arm may have the same angular position in a circumferential direction or may have an angular spacing. The friction ring may be mounted radially inward of the stop ring. An outer circumferential surface of the friction ring may be frictionally coupled with an inner circumferential surface of the stop ring. The driving element and the friction ring may each comprise a first cam. The first cams may be configured for defining the first rotational position where the driving element and the friction ring are relative to each other. The driving element and the friction ring may each comprise a second cam. The second cams may be configured to define the second rotational position where the driving element and the friction ring are relative to each other. A contact surface of the first cam of the driving element and the first cam of the friction ring may deviate from a radial plane with reference to the rotation axis. The stop ring may comprise a stator. The stop ring may be configured for limited rotation. The driving element may comprise a chamber comprising a bottom on one axial end side of the driving element. The chamber may be open on the other axial end side of the driving element. The stop ring, the friction ring and the pawls may be accommodated in the chamber. An axial stop disk may be connected with the driving element and may be mounted on the other opened axial end side. The driven element may be configured to enter the chamber by passing through an opening of the bottom. Portions of the pawls from the pivot axes to the free end portions may occupy an angular area of not more than 60 degrees in the first pivot position and/or in the second pivot position with reference to the rotation axis. Each pawl may comprise a locking component configured to lock with the driving element in a pass-through position for the pawl passing through the first pivot position in a radially-outward pivot direction when the pawl passes through the first pivot position in the radially-outward pivot direction. The locking components may comprise elastic components. In the first pivot position, the pawls may abut against the driving element through the locking components. Each locking component may comprise a hook portion configured to be hooked by the driving element when the pawl passes through the first pivot position in the radially-outward pivot direction, such that the pawl is held in the pass-through position. The locking components may be injection molded onto bodies of the pawls. The locking components may protrude from bodies of the pawls in a direction away from the free end portions of the pawls. The driving element may comprise projections comprising engaging hook portions. Each pawl may abut against a surface of the projection adjacent to the engaging hook portion through the hook portion in the first pivot position. The hook portion may slide on the projection when the pawl pivots relative to the driving element from the first pivot position towards the pass-through position such that the hook portion hooks the engaging hook portion. The friction ring may comprise elastic components configured to press the pawls and counteract the pawls leaving the first pivot position in a radially-inward pivot direction in the first pivot position of the pawls relative to the driving element. The elastic components of the friction ring may be out of contact with the pawls upon a predetermined stroke of the pawls away from the first pivot position in the radially-inward pivot direction. The elastic components of the friction ring may comprise finger-shaped elements injection-molded onto a ring body of the friction ring. The driving element and the driven element may comprise gears.

### FIGURES

FIG. 1A is a schematic perspective view of a vehicle according to an exemplary embodiment.

FIG. 1B is a schematic partial perspective view of a vehicle interior according to an exemplary embodiment.

FIG. 2 is a schematic exploded perspective view of a seatbelt retractor according to an exemplary embodiment.

FIG. 3A is a schematic perspective view of a belt retraction spool and a one-way clutch of a seatbelt retractor according to an exemplary embodiment.

FIG. 3B is a schematic perspective view of a structural unit of an active pre-tensioning device of a seatbelt retractor according to an exemplary embodiment.

FIG. 3C is a schematic exploded perspective view of a one-way clutch for a seatbelt retractor according to an exemplary embodiment.

FIGS. 4 and 5 are schematic front views of a one-way clutch for a seatbelt retractor according to an exemplary embodiment.

FIG. 6 is a schematic front view of a pawl of a one-way clutch for a seatbelt retractor according to an exemplary embodiment.

FIG. 7 is a schematic perspective view of a friction ring of a one-way clutch for a seatbelt retractor according to an exemplary embodiment.

FIG. 8A is a schematic partial perspective view of a friction ring of a one-way clutch for a seatbelt retractor according to an exemplary embodiment.

FIG. 8B is a schematic partial perspective view of a friction ring and a driving element of a one-way clutch for a seatbelt retractor according to an exemplary embodiment.

FIG. 9 is a schematic front view of a driving element of a one-way clutch for a seatbelt retractor according to an exemplary embodiment.

FIG. 10 is a schematic partial front view of a one-way clutch for a seatbelt retractor according to an exemplary embodiment.

### DESCRIPTION

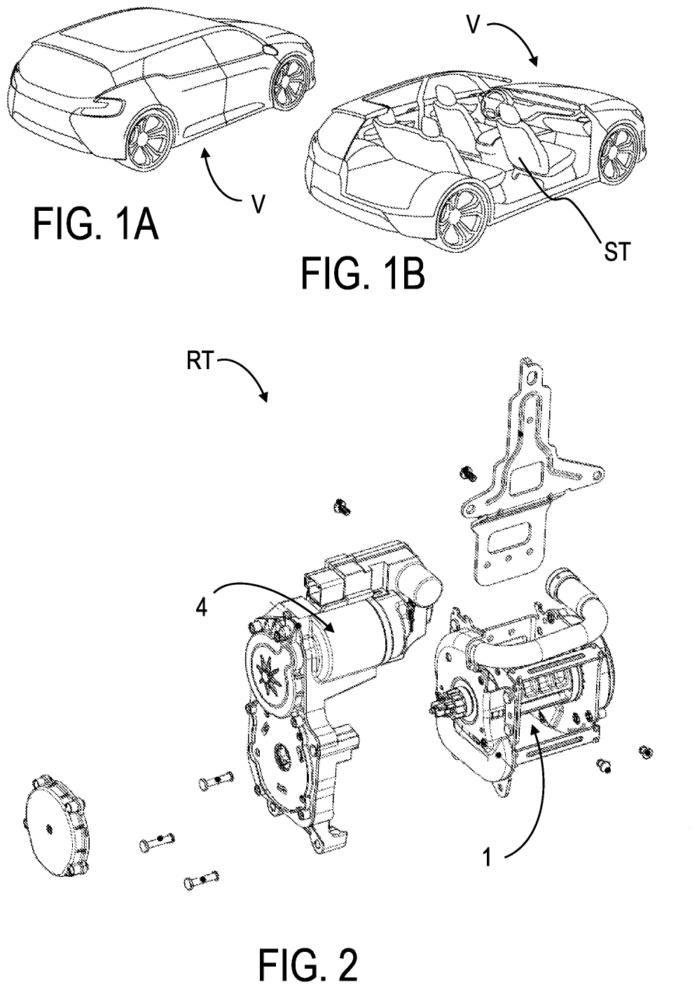

Referring to FIGS. 1A and 1B, a vehicle V is shown schematically with a seat ST. Seat ST may comprise a seatbelt retractor.

According to an exemplary embodiment as shown schematically in FIG. 2, a seatbelt retractor RT for a vehicle interior may comprise a belt retraction spool 1 configured to pretension a belt; a motor 4; a transmission coupled to the motor; and a one-way clutch coupled to the transmission.

According to an exemplary embodiment as shown schematically in FIGS. 2, 3A-3C, 4, 5, 6, 7, 8A, 8B, 9 and 10, a seatbelt retractor RT for a vehicle interior may comprise a belt; a belt retraction spool 1 configured to pretension the belt; a motor 4; a transmission 5 coupled to the motor; and a one-way clutch 10 coupled to the transmission. The one-way clutch may be configured for a disengaged state and an engaged state to pretension the belt. When the one-way clutch is in the engaged state, the motor may be configured to drive the belt retraction spool via the transmission device and the one-way clutch to pretension the belt. The one-way clutch may comprise a drive gear 11 and a driven gear 12. The drive gear may be configured to rotate in a first direction D to retract the belt and a second direction R opposite to the first direction. The drive gear and the driven gear may comprise a common axis of rotation 3. The one-way clutch may comprise a set of pawls 13 pivotably mounted on the drive gear. The one-way clutch may comprise a friction ring 14 frictionally coupled with a stop ring 15. The drive gear may be configured to rotate relative to the friction ring between a first rotational position and a second rotational position. When the drive gear is in the first rotational position, the set of pawls is in a first pivot position disengaged from the driven gear. When the drive gear is in the second rotational position, the pawls may be in a second pivot position engaged with the driven gear. Each pawl of the set of pawls may comprise a locking component 35 configured to lock with the drive gear. The locking component may be injection-molded onto a body of the pawl. The locking component may be configured to may protrude from a body of a pawl of the set of pawls in a direction away from a free end portion of the pawl. Each pawl of the set of pawls may comprise a free end portion 32 remote from a pivot axis parallel to the rotation axis; the free end portion may be configured for cooperation with the driven gear. The locking component may comprise an elastic component; a pawl of the set of pawls may be configured to abut against the drive gear through the locking component. The locking component may comprise a hook portion 36 configured to be hooked by the drive gear. The drive gear may comprise a projection 112 comprising an engaging hook portion 117. A pawl of the set of pawls may be configured to abut against a surface of the projection of the drive gear adjacent to the engaging hook portion through the hook portion in the first pivot position. The hook portion may be configured to slide on the projection to hook the engaging hook portion. The second pivot position may be pivoted radially inward from the first pivot position. A pawl of the set of pawls may comprise a sliding surface 33. The friction ring may comprise a guiding member 141, 142 configured to guide the sliding surface. When the drive gear rotates relative to the friction ring between the first rotational position and the second rotational position, the pawl may be configured to pivot relative to the drive gear between the first pivot position and the second pivot position through cooperation of the guiding member and the sliding surface. Each pawl may comprise a free end portion 32 adjacent the sliding surface; the free end portion may be configured for cooperation with the driven gear. The sliding surface may protrude axially from a body 31 of a pawl of the set of pawls. The set of pawls may comprise two pawls; the pivot axes of the two pawls may be aligned with one another. The two pawls may each comprise sliding surfaces. The friction ring may comprise a pair of guiding members configured to guide the sliding surfaces on two sides of the sliding surfaces. The pair of guiding members may comprise contact portions opposite to each other. The sliding surfaces may be guided between the contact portions. Each contact portion of the contact portions may comprise a cylindrical surface. A first guiding member 141 of the pair of guiding members may comprise a first portion 41 protruding inwardly from a ring body of the friction ring, a second portion 42 bent relative to the first portion at a radially inner end portion of the first portion, and a third portion 43 protruding axially from the second portion; the third portion may comprise a cylindrical body comprising a cylindrical surface. A second guiding member 142 of the pair of guiding members may comprise an arm protruding inwardly from the ring body of the friction ring, and a free end portion 44 of the arm, as the contact portion, may comprise a cylindrical surface. The third portion may be radially inward of the free end portion of the arm with reference to the rotation axis. The third portion and the free end portion of the arm may have the same angular position in a circumferential direction or may have an angular spacing. The friction ring may be mounted radially inward of the stop ring; an outer circumferential surface of the friction ring may be frictionally coupled with an inner circumferential surface of the stop ring. The drive gear and the friction ring may each comprise a first cam 114, 144. The first cam of the drive gear and the first cam of the friction ring may be configured to define the first rotational position. The drive gear and the friction ring may each comprise a second cam 115, 145. The second cam of the drive gear and the second cam of the friction ring may be configured to define the second rotational position. A contact surface of the first cam of the drive gear and the first cam of the friction ring may deviate from a radial plane with reference to the rotation axis. The stop ring (a) may comprise a stator or (b) may be configured for limited rotation. The drive gear may comprise a chamber comprising a bottom on one axial end side of the drive gear. The chamber may be open on the other axial end side of the drive gear. The stop ring, the friction ring and the pawls may be accommodated in the chamber. An axial stop disk 18 connected with the drive gear may be mounted on the other opened axial end side. The driven gear may be configured to enter the chamber by passing through an opening 116 of the bottom. A portion of the pawl may occupy an angular area of not more than 60 degrees from the pivot axes to the free end portions in the first pivot position and/or in the second pivot position with reference to the rotation axis. Each pawl of the set of pawls may comprise a locking component 35 configured to lock with the drive gear in a pass-through position for the pawl passing through the first pivot position in a radially-outward pivot direction when the pawl passes through the first pivot position in the radially-outward pivot direction. The locking component may comprise an elastic component. In the first pivot position, a pawl of the set of pawls may abut against the drive gear through the locking component. Each locking component may comprise a hook portion 36 configured to be hooked by the drive gear when the pawl passes through the first pivot position in the radially-outward pivot direction such that the pawl is held in the pass-through position. The drive gear may comprise projections 112 comprising engaging hook portions 117. Each pawl of the set of pawls may abut against a surface of a projection adjacent to the engaging hook portion through the hook portion in the first pivot position. The hook portion may be configured to slide on the projection when the pawl pivots relative to the drive gear from the first pivot position towards the pass-through position such that the hook portion hooks the engaging hook portion. The locking component may be injection-molded onto a body of a pawl of the set of pawls. The locking component may protrude from a body of a pawl of the set of pawls in a direction away from a free end portion of the pawl. The friction ring may comprise elastic components 146. The elastic components of the friction ring may be configured to press the set of pawls and counteract the set of pawls leaving the first pivot position in a radially-inward pivot direction in the first pivot position of the set of pawls relative to the drive gear. The elastic components of the friction ring may be out of contact with the set of pawls upon a predetermined stroke of the set of pawls away from the first pivot position in the radially-inward pivot direction. The elastic components of the friction ring may be finger-shaped elements injection-molded onto a ring body of the friction ring. The seatbelt retractor may be configured for assembly to a belt pre-tensioner.

According to an exemplary embodiment as shown schematically in FIGS. 2, 3A-3C, 4, 5, 6, 7, 8A, 8B, 9 and 10, a one-way clutch may comprise a driving element shown as drive gear 11 rotatable in a first direction D and a second direction R opposite to the first direction; a driven element shown as driven gear 12 having a common rotation axis 3 with the driving element; pawls 13 pivotably mounted on the driving element; a stop ring 15; and a friction ring 14 frictionally coupled with the stop ring. The driving element may be rotatable relative to the friction ring between a first rotational position and a second rotational position downstream of the first rotational position in the first direction. In the first rotational position, the pawls may be in a first pivot position relative to the driving element. In the first pivot position, the pawls may be disengaged from the driven element. In the second rotational position, the pawls are in a second pivot position relative to the driving element pivoted radially inward from the first pivot position. In the second pivot position, the pawls are engaged with the driven element. Each pawl may comprise a sliding surface 33. The friction ring may comprise guiding members 141, 142 for guiding the sliding surfaces on both sides of the sliding surfaces, and the pawls are pivotable relative to the driving element between the first pivot position and the second pivot position through cooperation of the guiding members and the sliding surfaces when the driving element rotates relative to the friction ring between the first rotational position and the second rotational position. Each pawl may comprise a free end portion 32 remote from a pivot axis parallel to the rotation axis. The free end portion may be configured for cooperation with the driven element. The sliding surfaces may protrude axially from bodies 31 of the pawls with reference to the pivot axes of the pawls. The one-way clutch may comprise two pawls, and the pivot axes of the two pawls may be on one diameter line with reference to the rotation axis. The friction ring may comprise a pair of guiding members for guiding the sliding surfaces on both sides of the sliding surfaces, the pair of guiding members may comprise contact portions opposite to each other, and the sliding surfaces are guided between the contact portions. Each contact portion may comprise a cylindrical surface. Each first guiding member 141 of the pair of guiding members may comprise a first portion 41 protruding inwardly from a ring body of the friction ring, a second portion 42 bent relative to the first portion at a radially inner end portion of the first portion, and a third portion 43 protruding axially from the second portion, the third portion, as the contact portion, being configured as a cylindrical body having a cylindrical surface; and/or each second guiding member 142 of the pair of guiding members may comprise an arm protruding inwardly from the ring body of the friction ring, and a free end portion 44 of the arm, as the contact portion, has a cylindrical surface. The third portion is radially inward of the free end portion of the arm with reference to the rotation axis, and/or the third portion and the free end portion of the arm may have the same angular position in a circumferential direction or may have an angular spacing. The friction ring is mounted radially inward of the stop ring, and an outer circumferential surface of the friction ring is frictionally coupled with an inner circumferential surface of the stop ring. The driving element and the friction ring may each comprise a first cam 114, 144. The first cams may be configured for defining the first rotational position where the driving element and the friction ring are relative to each other. The driving element and the friction ring may each comprise a second cam 115, 145. The second cams may be configured for defining the second rotational position where the driving element and the friction ring are relative to each other. A contact surface of the first cam of the driving element and the first cam of the friction ring may deviate from a radial plane with reference to the rotation axis. The stop ring may comprise a stator. The stop ring may be configured for limited rotation. The driving element may comprise a chamber having a bottom on one axial end side of the driving element and being open on the other axial end side of the driving element. The stop ring, the friction ring and the pawls may be accommodated in the chamber. An axial stop disk 18 connected with the driving element may be mounted on the other opened axial end side. The driven element may be configured to enter the chamber by passing through an opening 116 of the bottom. Portions of the pawls from the pivot axes to the free end portions may occupy an angular area of not more than 60 degrees in the first pivot position and/or in the second pivot position with reference to the rotation axis. Each pawl may comprise a locking component 35 configured to lock with the driving element in a pass-through position for the pawl passing through the first pivot position in a radially-outward pivot direction when the pawl passes through the first pivot position in the radially-outward pivot direction. The locking components may comprise elastic components. In the first pivot position, the pawls may abut against the driving element through the locking components. Each locking component may comprise a hook portion 36 configured to be hooked by the driving element when the pawl passes through the first pivot position in the radially-outward pivot direction such that the pawl is held in the pass-through position. The locking components may be injection-molded onto bodies of the pawls. The locking components may protrude from bodies of the pawls in a direction away from the free end portions of the pawls. The driving element may comprise projections 112 having engaging hook portions 117. Each pawl may abut against a surface of the projection adjacent to the engaging hook portion through the hook portion in the first pivot position. The hook portion may slide on the projection when the pawl pivots relative to the driving element from the first pivot position towards the pass-through position such that the hook portion hooks the engaging hook portion. The friction ring may comprise elastic components 146. The elastic components of the friction ring may press the pawls and counteract the pawls leaving the first pivot position in a radially-inward pivot direction in the first pivot position of the pawls relative to the driving element. The elastic components of the friction ring may be out of contact with the pawls upon a predetermined stroke of the pawls away from the first pivot position in the radially-inward pivot direction. The elastic components of the friction ring may comprise finger-shaped elements injection-molded onto a ring body of the friction ring. The driving element and the driven element may comprise gears. A seatbelt retractor may comprise a belt retraction spool 1, a driving device 4 and the one-way clutch 10. The driving device may be connected with a driving element 11 of the one-way clutch in a transmission manner. The belt retraction spool may be connected with a driven element shown as driven gear 12 of the one-way clutch in a transmission manner.

According to an exemplary embodiment as shown schematically in FIGS. 2, 3A-3C, 4, 5, 6, 7, 8A, 8B, 9 and 10, a one-way clutch may comprise a driving element shown as drive gear 11 rotatable in a first direction D and a second direction R opposite to the first direction; a driven element shown as driven gear 12 having a common rotation axis 3 with the driving element; pawls 13 pivotably mounted on the driving element; a stop ring 15; and a friction ring 14 frictionally coupled with the stop ring. The driving element is rotatable relative to the friction ring between a first rotational position and a second rotational position downstream of the first rotational position in the first direction. In the first rotational position, the pawls are in a first pivot position relative to the driving element. In the first pivot position, the pawls are disengaged from the driven element. In the second rotational position, the pawls are in a second pivot position relative to the driving element pivoted radially inward from the first pivot position. In the second pivot position, the pawls are engaged with the driven element. Each pawl may comprise a locking component 35 configured to lock with the driving element in a pass-through position for the pawl passing through the first pivot position in a radially-outward pivot direction when the pawl passes through the first pivot position in the radially-outward pivot direction. The locking components may comprise elastic components. In the first pivot position, the pawls may abut against the driving element through the locking components. Each locking component may comprise a hook portion 36 configured to be hooked by the driving element when the pawl passes through the first pivot position in the radially-outward pivot direction such that the pawl is held in the pass-through position. The driving element may comprise projections 112 having engaging hook portions 117. Each pawl may abut against a surface of the projection adjacent to the engaging hook portion through the hook portion in the first pivot position. The hook portion may be configured to slide on the projection when the pawl pivots relative to the driving element from the first pivot position towards the pass-through position such that the hook portion hooks the engaging hook portion. The locking components may be injection-molded onto bodies of the pawls. The locking components may protrude from bodies of the pawls in a direction away from free end portions of the pawls. Each pawl may comprise a free end portion 32 remote from a pivot axis parallel to the rotation axis. The free end portion may be configured for cooperation with the driven element.

### Exemplary Embodiments—A

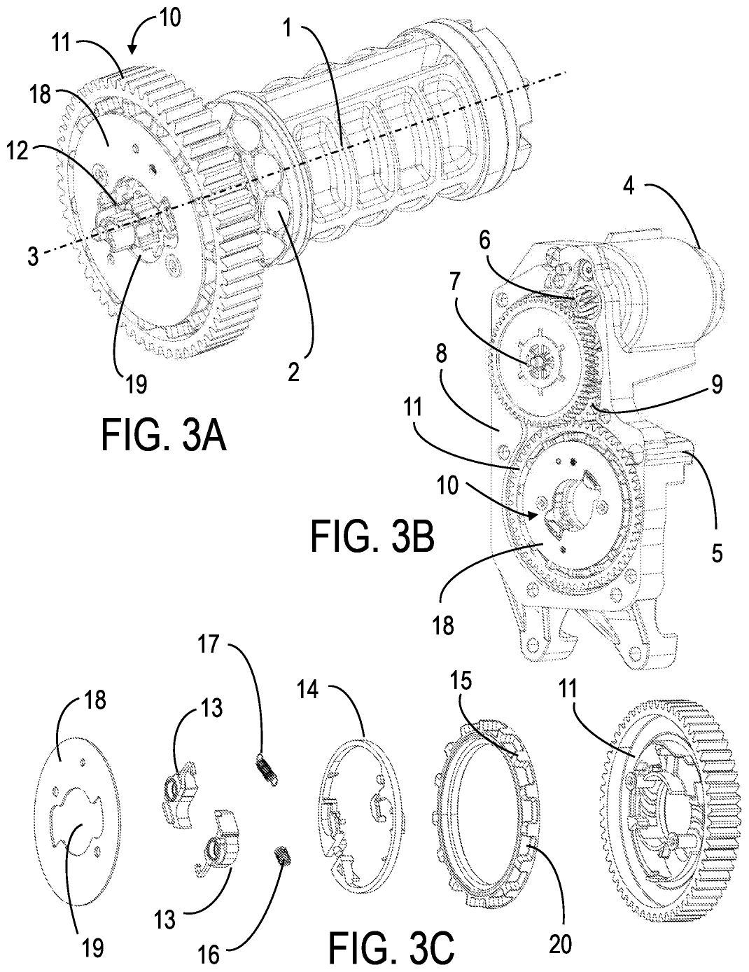

According to an exemplary embodiment as shown schematically in FIG. 3A, a seatbelt retractor may comprise a belt retraction spool 1 and a one-way clutch 10. According to an exemplary embodiment as shown schematically in FIG. 3B, a structural unit of an active pre-tensioning device of a seatbelt retractor may comprise a one-way clutch 10 and a driving device 4 configured as a reversible electric motor and a transmission device 5. The structural unit may be mounted on the belt retraction spool 1 as shown schematically in FIG. 3A. A gear (e.g. a ratchet) may be integrally formed with the belt retraction spool 1 or may be connected coaxially and anti-torsionally therewith, as a driven element shown as driven gear 12 of the one-way clutch 10. The gear may pass through a central opening of the one-way clutch 10. The driven element and the belt retraction spool 1 may have a common rotation axis 3. The reversible electric motor as the driving device 4 may be driven bidirectionally. The structural unit may form an active pre-tensioning device of the seatbelt retractor.

According to an exemplary embodiment, the seatbelt retractor may comprise a frame. The belt retraction spool 1 may be rotatably supported in the frame, and a housing component 8 of the transmission device 5 may be fixedly connected with the frame. According to an exemplary embodiment as shown schematically in FIG. 3B, the transmission device 5 may be configured as a gear transmission device having a housing. (To show the gear set accommodated inside the housing, another housing component of the housing is hidden to expose all gears of the gear set.) The two housing components of the housing of the transmission device 5 may be plastic components or metal components. The driving device 4 may be fixed onto the housing component 8 of the transmission device, for example by screws, to implement the fixed connection. The housing component 8 may be formed by injection molding. The housing component 8 may have a substantially cylindrical accommodating portion for accommodating a substantially cylindrical electric motor. A pinion 6 may be fixedly connected with an output shaft or an electric motor shaft of the driving device 4 or may be formed integrally therewith. The pinion may mesh with a transmission gear 7. The transmission gear may mesh with an intermediate gear 9. The transmission gear 7 and the intermediate gear 9 may rotate together with an output gear. The output gear may comprise a driving element of the one-way clutch. The one-way clutch 10 may comprise a module in a housing of the transmission device 5. The driving device 4 and the transmission device 5 may be selected from other equipment, such as hydraulic driving devices, belt transmission devices, wire rope transmission devices and friction gear transmission devices. A one-way driving device 4 is also possible if the transmission device 5 has a reversing mechanism.

According to an exemplary embodiment as shown schematically in FIG. 3A, a gear 2 (shown as a ball gear) may be assigned to an irreversible pre-tensioning device. The pre-tensioning device may comprise a gas generator, a coil pipe and a steel ball, a flexible rack, etc. For example, when powder of the gas generator is ignited, the gas generated by the gas generator may drive the steel ball, the flexible rack or the like accommodated in the coil pipe to be ejected from the coil pipe to impact the gear 2 to pre-tension the belt retraction spool 1 in the webbing belt retraction direction to improve restraint of an occupant during an event such as a vehicle collision.

FIG. 3C is an exploded view of a one-way clutch 10 for a seatbelt retractor according to an embodiment of the present invention, wherein the one-way clutch may be a composition of the seatbelt retractor comprising components shown schematically in FIGS. 3A and 3B.

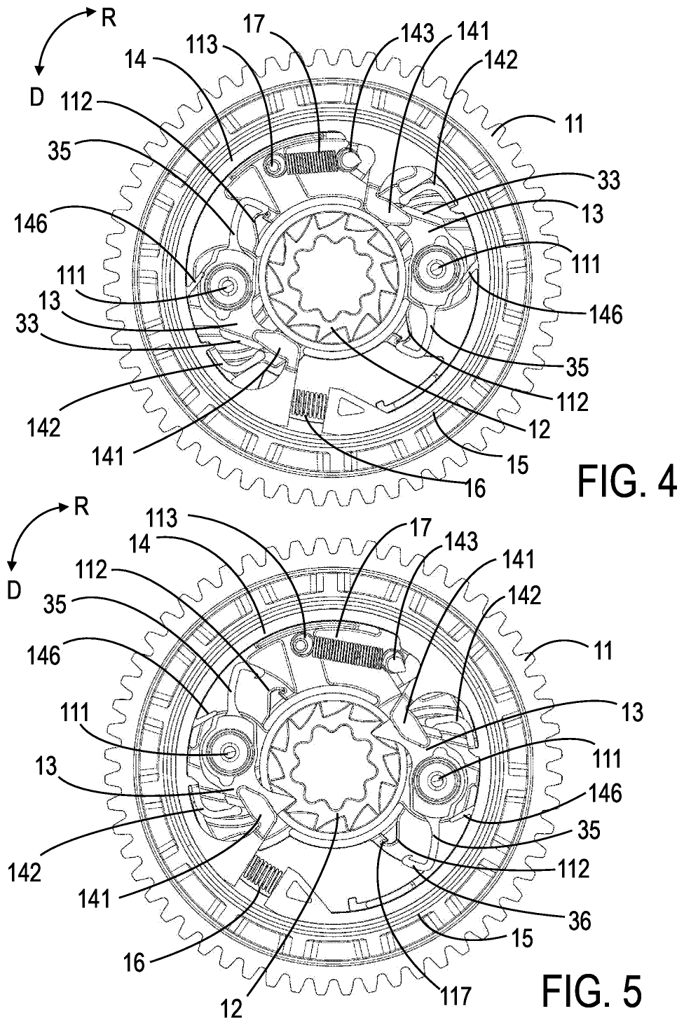

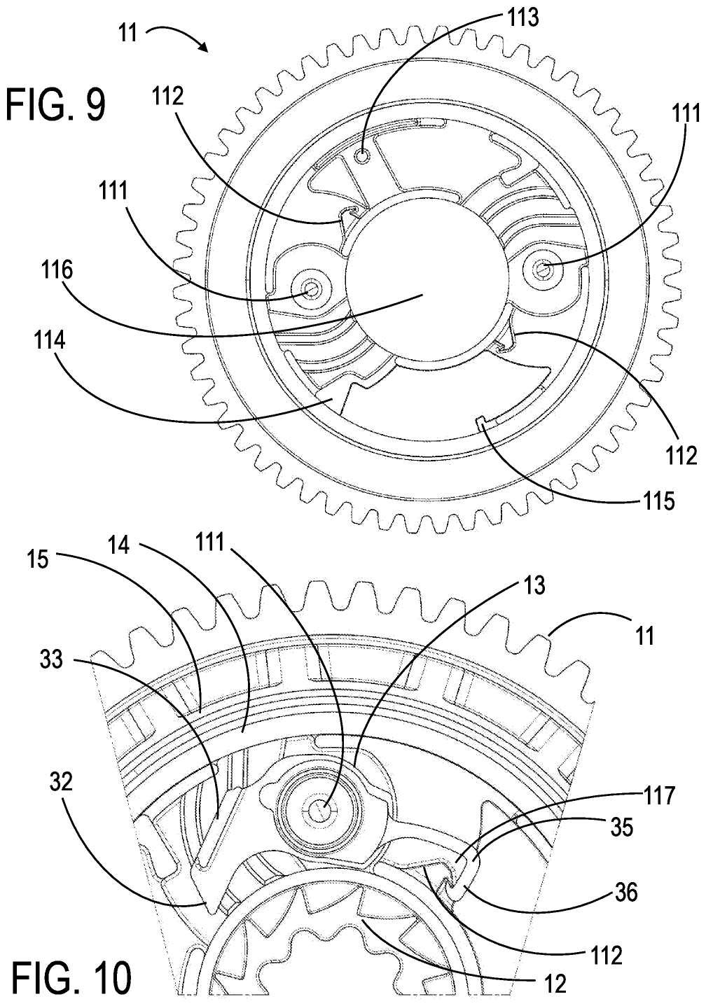

According to an exemplary embodiment, the one-way clutch 10 may comprise a driving element shown as drive gear 11. Driving device 4 may comprise a two-way driving device. The driving element may be rotatable in a first direction D and a second direction R opposite to the first direction (see FIGS. 4 and 5). The first direction D may correspond to a webbing belt retraction direction of the belt retraction spool 1. The second direction R may correspond to the webbing belt non-retraction direction of the belt retraction spool 1. The driving element may comprise an output gear of the transmission device 4. As shown schematically in FIGS. 3A-3C and 9, the driving element may have a chamber having a bottom on one axial end side of the driving element and being open on the other axial end side of the driving element, and an axial stop disk 18 connected with the driving element can be mounted on the other axial end side. The axial stop disk 18 may be a pressed disk which may be crimped onto two shaft pins 111 protruding from the bottom of the chamber of the driving element.

According to an exemplary embodiment, the one-way clutch 10 may comprise a stop ring 15, a friction ring 14 and two pawls 13, the pawls being pivotably mounted on the shaft pins 111. The shaft pins 111 may provide pivot axes for the pawls. The axial stop disk 18 can implement the axial positioning of the stop ring 15, the friction ring 14 and the pawls 13, so as to prevent any of them from disengaging from the chamber of the driving element. The two shaft pins 111 may be on one diameter line, in other words, may have an angular spacing of 180 degrees.

The one-way clutch 10 may comprise a driven element shown as driven gear 12, and the driven element and the driving element may have a common rotation axis 3 (see FIG. 3A). The driven element may be accommodated in the chamber. The driven element may be configured to enter the chamber of the driving element by passing through an opening 116 of the bottom of the driving element. The driven element may protrude from the axial stop disk 18 by passing through the opening 19 of the axial stop disk 18 as shown schematically in FIG. 3A.

The stop ring 15 may comprise a stator, which is an at least substantially stationary component. According to an exemplary embodiment, the stop ring 15 may be capable of limited rotation. For example, the stop ring may be capable of limited rotation within an angular range of less than 30 degrees, for example 20 degrees to 30 degrees, or less than 10 degrees. The housing component may have at least one, for example three, pins which, during assembly, are inserted into recesses 20 (see FIG. 3C) in the outer circumference of the stop ring 15. The pins may be configured to substantially prevent the stop ring 15 from rotating or may be configured to allow a limited rotation of the stop ring 15.

According to an exemplary embodiment, the friction ring 14 may be frictionally coupled with the stop ring 15. The friction ring 14 may be mounted radially inward of the stop ring 15. An outer circumferential surface of the friction ring 14 may be frictionally coupled with an inner circumferential surface of the stop ring 15. The friction ring 14 may comprise two end portions opposite to each other, and a compression spring 16 may be mounted between the two end portions, such that the friction ring 14 may maintain the frictional coupling with the stop ring 15. In the course of operation of the one-way clutch 10, the friction ring 14 and the stop ring 15 may remain stationary before the friction force between the friction ring 14 and the stop ring 15 is removed; after this friction force is removed, the friction ring 14 may rotate relative to the stop ring 15.

FIG. 4 is a front view of the one-way clutch 10 of FIG. 3C in a first state, and FIG. 5 is a front view of the one-way clutch 10 in a second state, wherein, in order to show the internal structure, the axial stop disk 18 of the one-way clutch 10 is removed to expose the structure of the one-way clutch 10 in the chamber of the driving element that is hidden by the axial stop disk 18.

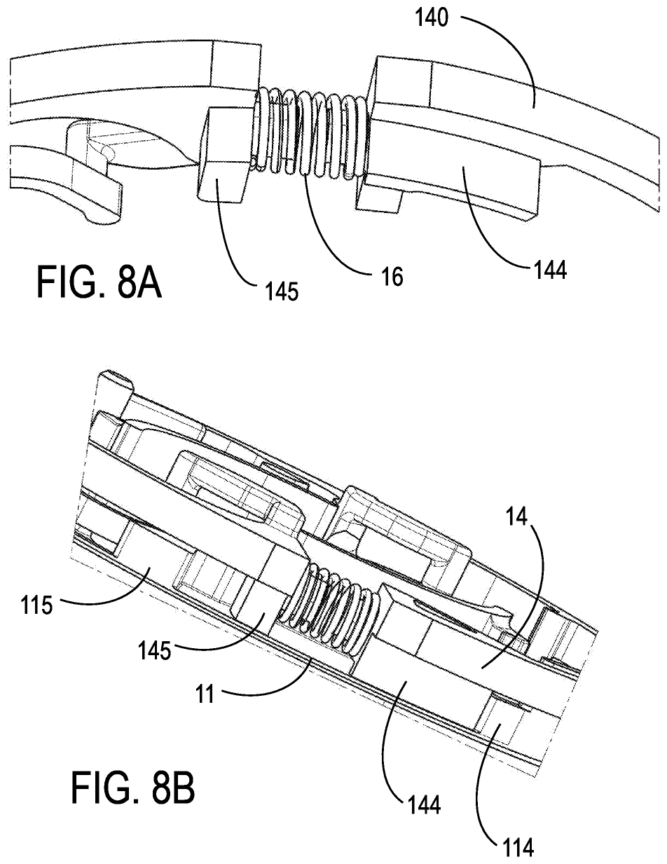

According to an exemplary embodiment as shown schematically in FIG. 4, in the first state of the one-way clutch 10, the driving element may be in a first rotational position relative to the friction ring 14. The first rotational position may be defined by one first cam 114, 144 on each of the driving element and the friction ring 14. As shown schematically in FIG. 8B, the first cam 114 of the driving element may abut against the first cam 144 of the friction ring 14, thereby defining a first rotational position where the driving element and the friction ring 14 are relative to each other, and at the moment, the second cam 115 of the driving element is disengaged from the second cam 145 of the friction ring 14. Starting from the first state, when the driving element rotates in the second direction R, the friction ring 14 rotates together with the driving element in the second direction R, wherein the first rotational position where the driving element and the friction ring 14 are relative to each other can be kept unchanged.

According to an exemplary embodiment as shown schematically in FIG. 5, in the second state of the one-way clutch 10, the driving element may be in a second rotational position relative to the friction ring 14. The second rotational position may be defined by one second cam 115, 145 on each of the driving element and the friction ring 14. According to an exemplary embodiment as shown schematically in FIG. 8B, the second cam 115 of the driving element may abut against the second cam 145 of the friction ring 14, thereby defining a second rotational position where the driving element and the friction ring 14 are relative to each other, and at the moment, the first cam 114 of the driving element is disengaged from the first cam 144 of the friction ring 14. Starting from the second state, when the driving element rotates in the first direction D, the friction ring 14 rotates together with the driving element in the first direction D, wherein the second rotational position where the driving element and the friction ring 14 are relative to each other can be kept unchanged.

According to an exemplary embodiment as shown schematically in FIG. 8A, the first cam 144 and the second cam 145 of the friction ring 14 may be arranged in regions of the free end portions of the friction ring which are opposite to each other and protrude axially from the ring body 140 (see FIG. 7) of the friction ring. The two cams of the friction ring may be arranged at any suitable position.

With reference to the rotation axis 3, when the first cam 114 of the driving element abuts against the first cam 144 of the friction ring 14, the force of the first cam 114 of the driving element on the first cam 144 of the friction ring 14 deviates from a tangential direction. With regard to the movement of the contact surface of the first cam 114 of the driving element, reference can be made to FIG. 9, wherein the movement deviates from a radial direction.

The friction ring 14 may comprise a guiding structure configured to cooperate with the pawls 13. The guiding structure may be configured to: guide the pawls 13 to be in a first pivot position relative to the driving element in a first rotational position of the driving element relative to the friction ring 14, the pawls 13 being disengaged from the driven element in the first pivot position as shown schematically in FIG. 4, and guide the pawls 13 to be in a second pivot position relative to the driving element in a second rotational position of the driving element relative to the friction ring 14, the pawls 13 being engaged with the driven element in the second pivot position as shown schematically in FIG. 5.

According to an exemplary embodiment, an active pre-tensioning process of the active pre-tensioning device comprising the one-way clutch 10 may start from a first state as shown schematically in FIG. 4. The driving device 4 may drive the driving element of the one-way clutch 10 in a first direction D (e.g. according to a control instruction). The friction ring 14 may be held stationary with the stop ring 15 by means of frictional coupling. The driving element may rotate relative to the friction ring 14 to the second rotational position where the driving element and the friction ring are relative to each other as shown schematically in FIG. 5 from the first rotational position where the driving element and the friction ring are relative to each other, and meanwhile, the pawls 13 pivot relative to the driving element to the second pivot position as shown schematically in FIG. 5 from the first pivot position as shown schematically in FIG. 4. Then, as the mating second cams 115, 145 meet, the friction force of the friction ring 14 and the stop ring 15 is removed by the driving force of the driving element, and the friction ring 14 rotates together with the driving element in the first rotational direction D. Since the pawls 13 are engaged with the driven element, the driving force is transmitted from the driving element to the belt retraction spool 1 via the pawls 13 and the driven element, such that the belt retraction spool 1 pretensions the webbing belt in the webbing belt retraction direction. The rotational stroke of the driving element in the first rotational direction D can be predetermined. The reaching of the rotational stroke may for example be related to at least one of the following conditions: a predetermined pre-tensioning degree is reached on the webbing belt; the driving element rotates by a set angle in the first rotational direction D; the electric motor runs for a predetermined time; the current of the electric motor reaches a predetermined threshold value.

According to an exemplary embodiment, a process of deactivating the active pre-tensioning function of the active pre-tensioning device may start from a second state as shown schematically in FIG. 5. The driving device 4 may drive the driving element of the one-way clutch 10 in a second direction R (e.g. according to a control instruction). The friction ring 14 may be held stationary with the stop ring 15 by means of frictional coupling. The driving element rotates relative to the friction ring 14 to the first rotational position where the driving element and the friction ring are relative to each other as shown schematically in FIG. 4 from the second rotational position where the driving element and the friction ring are relative to each other, and meanwhile, the pawls 13 pivot relative to the driving element to the first pivot position as shown schematically in FIG. 4 from the second pivot position as shown schematically in FIG. 5, the pawls 13 being disengaged from the driven element. Then, as the mating first cams 114, 144 meet, the friction force of the friction ring 14 and the stop ring 15 is removed by the driving force of the driving element, and the friction ring 14 rotates together with the driving element in the second rotational direction R, collectively returning to the initial position. As the pawls 13 are disengaged from the driven element, the belt retraction spool 1 can be operated independently of the active pre-tensioning device.

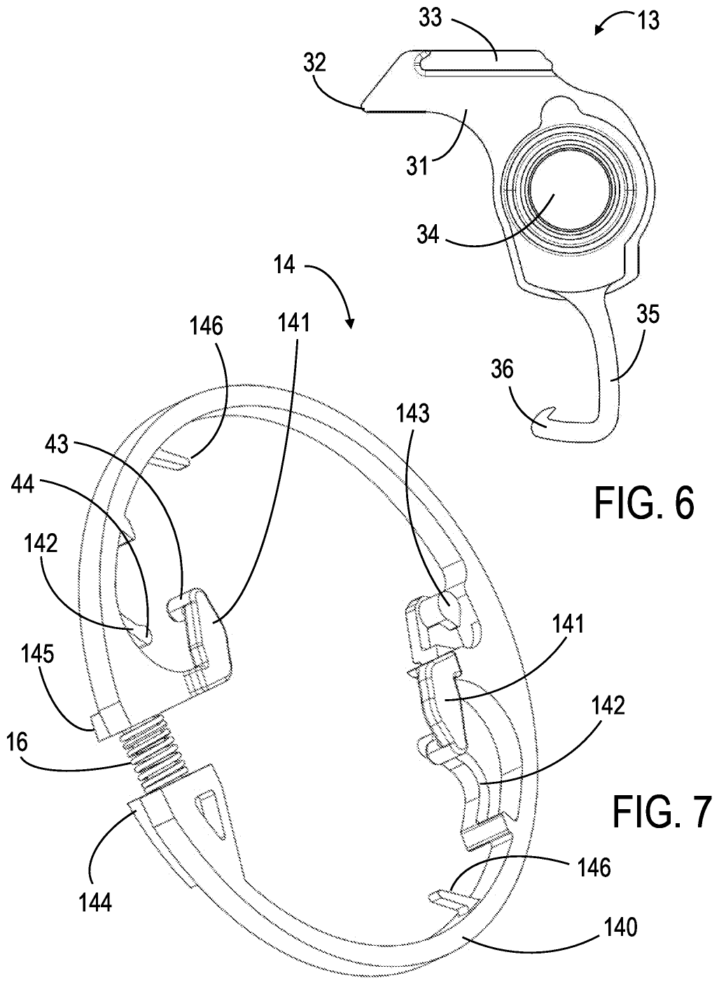

According to an exemplary embodiment as shown schematically in FIG. 6, the two pawls 13 of the one-way clutch 10 may be identically or similarly configured. The pawl 13 may comprise a body 31. The body 31 may be made by casting or powder metallurgy. The body 31 may comprise a shaft hole 34. The pawls 13 may be be pivotably mounted on the shaft pins 111 of the driving element through the shaft holes 34. The shaft holes 34 or the shaft pins 111 may define the pivot axes of the pawls 13 which may be parallel to the rotation axis 3. Each pawl 13 may comprise a free end portion 32 remote from the pivot axis. The free end portion 32 may be configured for cooperation with the driven element configured as a gear or a ratchet.

According to an exemplary embodiment, the pawls 13 may comprise flat outer-side surfaces, and the sliding surfaces 33 may be coplanar with the outer-side surfaces. The sliding surfaces 33 may protrude axially from the bodies 31 of the pawls 13. The sliding surfaces 33 can cooperate with the guiding structure of the friction ring 14, such that the pawls 13 can pivot accordingly between the first pivot position and the second pivot position relative to the driving element when the driving element rotates between the first rotational position and the second rotational position relative to the friction ring 14. Each pawl 13 may occupy a small angular area on the entire circumference of the driving element. For example, with reference to the rotation axis 3, a composition of each pawl 13 from the pivot axis to the free end portion 32 occupies an angular area of not more than 60 degrees in the first pivot position and/or in the second pivot position, for example not more than 45 degrees, in particular not more than 30 degrees, and especially not more than 20 degrees.

According to an exemplary embodiment as shown schematically in FIG. 7, the friction ring 14 may comprise a pair of guiding members 141, 142 configured to guide the sliding surface 33 of the pawl 13 on both sides of the sliding surface 33. The pair of guiding members 141, 142 may comprise contact portions opposite to each other, and the sliding surface 33 may be guided between the contact portions.

According to an exemplary embodiment, each first guiding member 141 of the pair of guiding members may comprise a first portion 41 protruding inwardly from a ring body 140 of the friction ring 14, a second portion 42 bent relative to the first portion 41 at a radially inner end portion of the first portion 41, and a third portion 43 protruding axially from the second portion 42. The first portion 41 may have a width that decreases from a radially outward portion to a radially inward portion. The second portion 42 may be plate-shaped, wherein the plate-shaped body can extend substantially in a radial plane perpendicular to the rotation axis of the friction ring (which may coincide with the rotation axis 3 of the belt retraction spool 1 or of the driven element. As a contact portion, the third portion 43 may be configured as a cylindrical body having a cylindrical surface. The sliding surface 33 may be in linear contact with the cylindrical surface of the third portion 43. Each second guiding member 142 of the two guiding members may comprise an arm protruding inwardly from the ring body of the friction ring 14, and a free end portion 44 of the arm, as the contact portion, may have a cylindrical surface. The arm may be a curved arm. For example, the curved arm may comprise a first section extending substantially in a circumferential direction and a second section extending substantially in a radial direction with reference to the rotation axis 3. The third portion 43 may be radially inward of the free end portion of the arm with reference to the rotation axis 3. With reference to the rotation axis 3, the third portion 43 and the free end portion 44 of the arm may have substantially the same angular position in the circumferential direction or be spaced apart from each other (in other words, have an angular spacing).

According to an exemplary embodiment as shown schematically in FIGS. 3C, 4, 5 and 6, the pawls 13 may comprise locking components 35. The locking component 35 may comprise an elastic component. The locking component 35 may comprise a hook portion 36. The locking components 35 may be injection-molded onto bodies 31 of the pawls 13. The locking components 35 may protrude from the bodies 31 of the pawls 13 in a direction away from the free end portions 32 of the pawls 13.

According to an exemplary embodiment, in a first pivot position of the driving element relative to the friction ring 14, the pawls 13 may abut against the driving element through the locking components 35. The driving element may have projections 112, and the locking components 35 can abut against the projections 112 through the hook portions 36 in the first pivot position of the pawls 13. The projections 112 may be injection-molded onto the bottom of the chamber of the driving element. Each projection 112 may have an engaging hook portion 117 that cooperates with a hook portion of one locking component 35. The driving element may comprise a plastic gear. The driving element may be made by injection molding. The projections 112 may be an integrally formed composition of the injection-molded driving element. The driving element may comprise a metallic body. The projections 112 may be injection-molded onto the metallic body.

When the pawls 13 pivot relative to the driving element from the first pivot position in the radially inward pivot direction, the locking components 35 may be lifted from the projections 112. The projections 112 may not interfere with the active pre-tensioning function.

If the irreversible pre-tensioning device is activated immediately after activation of the active pre-tensioning device, the powder of the pyrotechnic gas generator of the irreversible pre-tensioning device is ignited, then the belt retraction spool 1 is driven by the irreversible pre-tensioning device in the webbing belt retraction direction at a significantly-increased rotational speed, and thus the driven element rotating at a high speed impacts the pawls 13 with high energy, such that the pawls 13 bounce from the second pivot position in the radially-outward pivot direction towards the first pivot position and pass through the first pivot position. The locking components 35 of the pawls 13 are then locked with the driving element in the pass-through position. The hook portions 36 of the locking components 35 may slide on the projections 112 of the driving element until the hook portions 36 of the locking components 35 hook the engaging hook portions 117 of the projections 112, so that the pawls 13 can no longer pivot around the pivot axes, remaining disengaged from the driven element, as shown schematically in FIG. 9. The active pre-tensioning device may not interfere with the irreversible pre-tensioning function and a force limiting function which is possibly set of the seatbelt retractor, which can improve the operational safety of the seatbelt.

According to an exemplary embodiment as shown schematically in FIGS. 3C, 4 and 5, the one-way clutch 10 may comprise a return spring 17. The driving element may comprise a shaft pin 113 and the friction ring 14 may comprise a shaft pin 143. Two ends of the return spring 17 may be hooked onto the shaft pins 113, 143. In the unloaded state, the return spring 17 may hold the friction ring 14 together with the stop ring 15 in the initial position relative to the driving element.

As shown schematically in FIGS. 3C, 4, 5 and 7, the friction ring 13 may have elastic components 146, wherein the elastic components 146 press the pawls 13 and counteract the pawls 13 leaving the first pivot position in a radially-inward pivot direction in the first pivot position of the pawls 13 relative to the driving element. The elastic components 146 are out of contact with the pawls 13 upon a predetermined stroke of the pawls 13 away from the first pivot position in the radially-inward pivot direction, which does not interfere with the active pre-tensioning function. The elastic components 146 may be finger-shaped elements injection-molded onto the ring body 140 of the friction ring. In the first pivot position, the rotational direction of the finger-shaped elements may be opposite to the rotational direction of the free end portions of the pawls, with reference to the pivot axes of the pawls 13. As shown schematically in FIG. 4, the extension direction of the finger-shaped elements is right-handed and the rotational direction of the free end portions 32 is left-handed, with reference to the pivot axes of the pawls 13. In the initial position of the pawls 13, the locking components 35 of the pawls 13, which are configured as elastic components, can counteract the pivot movement of the pawls 13 in the radially-outward pivot direction, and the elastic components 146 of the friction ring 14 can counteract the pivot movement of the pawls 13 in the radially-inward direction, so that it is possible to dampen vibrations of the pawls 13 around the pivot axes in the initial position to avoid the pawls 13 from shaking, so that the noise from collisions of other components of the one-way clutch 10 caused thereby is further avoided.

It should be noted that the terms used herein are only for the purpose of describing particular aspects and are not intended to limit the present disclosure. As used herein, the singular forms “a”, “an” and “the” are intended to include the plural forms, unless otherwise clearly expressed herein. It will be understood that the terms “comprise”, “include” and “comprising” and other similar terms, when used in this application document, specify the presence of stated operations, elements and/or components, but do not preclude the presence or addition of one or more other operations, elements, components, and/or combinations thereof. As used herein, the term “and/or” includes all arbitrary combinations of one or more of the related listed items. In the description of the drawings, like reference numerals refer to like elements throughout.

The thickness of elements in the accompanying drawings may be exaggerated for clarity. It will also be understood that if one element is referred to as being “on”, “coupled with” or “connected with” the other element, the element may be directly on, coupled with or connected with the other element, or there are one or more elements inserted therebetween. Conversely, if the expressions “directly on . . . ”, “directly coupled with . . . ” and “directly connected with . . . ” are used herein, then there are no elements inserted therebetween. Other words used to describe the relation between elements, such as “between . . . ” and “directly between . . . ”, “attached” and “directly attached”, and “adjacent” and “directly adjacent”, should be similarly interpreted.

The terms, such as “top”, “bottom”, “above”, “below”, “on” and “under”, are used herein to describe the relation between one element, layer or region with another element, layer or region as shown schematically in the figures. It will be understood that these terms are intended to encompass other orientations of the devices in addition to the orientations described in the figures.

It will be understood that, although the terms “first”, “second” and the like may be used herein to describe various elements, these elements should not be limited by these terms. These terms are only used to distinguish one element from another. Thus, a first element may be called a second element without departing from the teachings of the present invention.

The above-mentioned embodiments are only intended to understand the present invention and do not limit the protection scope of the present invention. It will be apparent to those skilled in the art that modifications may be made to the above-mentioned embodiments without departing from the protection scope of the present invention.

### Exemplary Embodiments—B

According to an exemplary embodiment, a seatbelt retractor may comprise a one-way clutch. An active pre-tensioning function for the seatbelt retractor may be inserted into the seatbelt retractor through the one-way clutch and then can be deactivated again. The one-way clutch may be switched and held in an inoperative state when an irreversible pre-tensioning device is activated, and the active pre-tensioning device may be deactivated without the irreversible pre-tensioning function being impaired.

According to an exemplary embodiment, a one-way clutch may comprise a driving element rotatable in a first direction and a second direction opposite to the first direction; a driven element having a common rotation axis with the driving element; pawls pivotably mounted on the driving element; a stop ring; and a friction ring frictionally coupled with the stop ring.

According to an exemplary embodiment, the driving element may be configured to rotate relative to the friction ring between a first rotational position and a second rotational position downstream of the first rotational position in the first direction. In the first rotational position, the pawls are in a first pivot position relative to the driving element, and in the first pivot position, the pawls are disengaged from the driven element; in the second rotational position, the pawls are in a second pivot position relative to the driving element pivoted radially inward from the first pivot position, and in the second pivot position, the pawls are engaged with the driven element.

According to an exemplary embodiment, each pawl may comprise a sliding surface, the friction ring may comprise guiding members configured to guide the sliding surfaces on both sides of the sliding surfaces, and the pawls are configured to pivot relative to the driving element between the first pivot position and the second pivot position through cooperation of the guiding members and the sliding surfaces when the driving element rotates relative to the friction ring between the first rotational position and the second rotational position.

According to an exemplary embodiment, each pawl may comprise a locking component configured to lock with the driving element in a pass-through position for the pawl passing through the first pivot position in a radially-outward pivot direction when the pawl passes through the first pivot position in the radially-outward pivot direction.

According to an exemplary embodiment, an active pre-tensioning function for the seatbelt retractor may be inserted into the seatbelt retractor through the one-way clutch and then can be deactivated again. The one-way clutch may be switched and held in the inoperative state when the irreversible pre-tensioning device is activated, and the active pre-tensioning device may be deactivated without the irreversible pre-tensioning function being impaired, which can mean increased operational safety of the seatbelt.

According to an exemplary embodiment, the driving element may be a gear, a friction gear, a belt pulley, or a cylindrical gear.

According to an exemplary embodiment, the driven element may be a gear or a ratchet.

According to an exemplary embodiment, the pawl may have a single pawl portion configured for cooperation with the driven element.

According to an exemplary embodiment, each pawl may have a free end portion remote from a pivot axis, and in particular from a pivot axis parallel to the rotation axis, the free end portion being configured for cooperation with the driven element.

According to an exemplary embodiment, the sliding surfaces may protrude axially from bodies of the pawls with reference to the pivot axes.

According to an exemplary embodiment, the bodies of the pawls may have flat outer-side surfaces, and the sliding surfaces may be coplanar with the outer-side surfaces.

According to an exemplary embodiment, the one-way clutch may comprise two pawls.

According to an exemplary embodiment, the pivot axes of the two pawls are on one diameter line with reference to the rotation axis, in other words, the two pawls or the two pivot axes may have an angular spacing of 180 degrees. It will be appreciated that the angular spacing of the two pawls may be other than 180 degrees, for example the angular spacing may be 90 degrees, 120 degrees or 150 degrees.

According to an exemplary embodiment, the one-way clutch may comprise three pawls. Preferably, with reference to the rotation axis, the pivot axes of the three pawls may have an angular spacing of 120 degrees from one another.

The number of pawls may be arbitrary, for example, there may be a single pawl.

According to an exemplary embodiment, the friction ring may have a single guiding member for each sliding surface, wherein the guiding member may have a radially-inward contact portion and a radially-outward contact portion, and the sliding surface is guided between the radially-inward contact portion and the radially-outward contact portion.

According to an exemplary embodiment, the friction ring may have a pair of guiding members configured to guide the sliding surfaces on both sides of the sliding surfaces, wherein the pair of guiding members have contact portions opposite to each other, and the sliding surfaces are guided between the contact portions.

According to an exemplary embodiment, any one of the contact portions may be configured for single-point, multiple-point, linear or planar contact with the sliding surfaces.

According to an exemplary embodiment, the contact portion may have a cylindrical surface. The cylindrical surface may be in linear contact with the sliding surface. The cylindrical surface may be a cylindrical surface or an elliptic cylindrical surface, or may be a portion of a cylindrical surface or an elliptic cylindrical surface.

According to an exemplary embodiment, each first guiding member of the pair of guiding members may comprise a first portion protruding inwardly from a ring body of the friction ring, a second portion bent relative to the first portion at a radially inner end portion of the first portion, and a third portion protruding axially from the second portion. Preferably, the second portion may be plate-shaped, and more preferably, the second portion extends in a radial plane perpendicular to the rotation axis. Preferably, as a contact portion, the third portion may be configured as a cylindrical body having a cylindrical surface.

According to an exemplary embodiment, each second guiding member of the pair of guiding members may comprise an arm protruding inwardly from the ring body of the friction ring. Preferably, as a contact portion, the free end portion of the arm may have a cylindrical surface. Preferably, the arm may be a curved arm. More preferably, the curved arm may comprise a first section extending substantially in a circumferential direction and a second section extending substantially in a radial direction with reference to the rotation axis.

According to an exemplary embodiment, the third portion may be radially inward of the free end portion of the arm with reference to the rotation axis.

According to an exemplary embodiment, with reference to the rotation axis, the third portion and the free end portion of the arm may have substantially the same angular position in the circumferential direction or have an angular spacing, for example may have an angular spacing of 1 degrees to 3 degrees.

According to an exemplary embodiment, the friction ring may be mounted radially inward of the stop ring, wherein an outer circumferential surface of the friction ring may be frictionally coupled with an inner circumferential surface of the stop ring.

As an equivalent to “frictional coupling”, the friction ring may be coupled with the stop ring by magnetic force. For this purpose, at least one of the friction ring and the stop ring may have a permanent magnet. The friction ring may rotate relative to the stop ring in the case of removing the magnetic force.

According to an exemplary embodiment, the driving element and the friction ring may each have a first cam, the first cams being configured for defining the first rotational position where the driving element and the friction ring are relative to each other.

According to an exemplary embodiment, the driving element and the friction ring may each have a second cam, the second cams being configured for defining the second rotational position where the driving element and the friction ring are relative to each other.

Alternatively, one of the driving element and the friction ring may have one cam, and the other of the driving element and the friction ring may have two cams, the one cam being movable between the two cams. By means of cooperation of the one cam and the two cams, the first rotational position and the second rotational position where the driving element and the friction ring are relative to each other may be defined.

According to an exemplary embodiment, a contact surface of the first cam of the driving element and the first cam of the friction ring may be deviated from a radial plane with reference to the rotation axis. Thus, when the mating first cams are in contact, the force perpendicular to the contact surface is deviated from a tangential direction.

According to an exemplary embodiment, the stop ring may be a stator. This means that the stator is an at least substantially-stationary component. Due to manufacturing tolerances or due to assembly requirements, the stop ring may be moved slightly after mounting, for example, a movement gap of the stop ring may be not more than 3 degrees.

According to an exemplary embodiment, the stop ring is capable of limited rotation, for example, the stop ring is capable of limited rotation within an angular range of less than 30 degrees, for example 20 degrees to 30 degrees, or less than 10 degrees.

According to an exemplary embodiment, in order to limit the movement of the stop ring, a housing component of the transmission device may have a pin capable of being inserted into a recess of the stop ring.

According to an exemplary embodiment, the driving element may have a chamber having a bottom on one axial end side of the driving element and being open on the other axial end side of the driving element, wherein the stop ring, the friction ring and the pawls may be accommodated in the chamber. Preferably, an axial stop disk connected with the driving element may be mounted on the other opened axial end side. The driven element is capable of entering the chamber by passing through an opening of the bottom. The axial stop disk may also have an opening through which the driven element can pass if the driven element is to observe the entire one-way clutch. Preferably, the opening of the axial stop disk may be formed identically to the opening of the bottom of the driving element.

According to an exemplary embodiment, with reference to the rotation axis, compositions of the pawls from the pivot axes to the free end portions occupy an angular area of not more than 90 degrees in the first pivot position and/or in the second pivot position, in particular not more than 60 degrees, for example not more than 45 degrees, and particularly preferably not more than 30 degrees or not more than 20 degrees. Therefore, the pawls occupy a small space in the one-way clutch, such that the entire one-way clutch may be structurally compact.

According to an exemplary embodiment, each pawl may have a locking component configured to lock with the driving element in a pass-through position for the pawl passing through the first pivot position in a radially-outward pivot direction when the pawl passes through the first pivot position in the radially-outward pivot direction.

According to an exemplary embodiment, the locking component may be a clip element capable of being clipped into a mating clip seat.

According to an exemplary embodiment, the locking component may be a spring lock buckle capable of locking in a pass-through position.

According to an exemplary embodiment, the locking component may be a hook-shaped component, and in particular an elastic hook-shaped component.

According to an exemplary embodiment, the locking component may be an elastic component, and in the first pivot position, the pawls abut against the driving element through the locking components.

According to an exemplary embodiment, the locking component may have a hook portion configured to be hooked by the driving element when the pawl passes through the first pivot position in the radially-outward pivot direction, such that the pawl is held in the pass-through position.

According to an exemplary embodiment, the locking components may be injection-molded onto bodies of the pawls.

According to an exemplary embodiment, the locking components protrude from the bodies of the pawls in a direction away from the free end portions of the pawls.

According to an exemplary embodiment, the driving element may have projections having engaging hook portions, wherein each pawl abuts against a surface of the projection adjacent to the engaging hook portion through the hook portion in the first pivot position, and the hook portion may slide on the projection when the pawl pivots relative to the driving element from the first pivot position towards the pass-through position, such that the hook portion hooks the engaging hook portion.

According to an exemplary embodiment, the projections may be injection-molded onto the driving element. In particular, the projections may be injection-molded onto the bottom of the chamber of the driving element.

According to an exemplary embodiment, the friction ring may have elastic components, wherein the elastic components of the friction ring press the pawls and counteract the pawls leaving the first pivot position in a radially-inward pivot direction in the first pivot position of the pawls relative to the driving element. Thus, in the first pivot position of the pawls, the elastic components may dampen vibrations of the pawls to avoid the pawls from shaking, so that the noise from collisions of other components of the one-way clutch caused thereby is further avoided.

According to an exemplary embodiment, the elastic components of the friction ring may be out of contact with the pawls upon a predetermined stroke of the pawls away from the first pivot position in the radially-inward pivot direction. Accordingly, the elastic components of the friction ring may substantially completely not influence the active pre-tensioning function of the one-way clutch.

According to an exemplary embodiment, the elastic components of the friction ring may be finger-shaped elements injection-molded onto a ring body of the friction ring.

A second aspect of the present invention relates to a seatbelt retractor comprising a belt retraction spool, a driving device and a one-way clutch, wherein the driving device is connected with a driving element of the one-way clutch in a transmission manner, and the belt retraction spool is connected with a driven element of the one-way clutch in a transmission manner.

According to an exemplary embodiment, the driving device is a reversible electric motor.

According to an exemplary embodiment, the driving device may be connected with a driving element of the one-way clutch through the transmission device in a transmission manner. The driving element may be an output gear of the transmission device, and in particular a cylindrical gear.

According to an exemplary embodiment, the transmission device may be a gear transmission device comprising a housing and a gear set accommodated in the housing. Alternatively, belt transmission or wire rope transmission may also be possible.

According to an exemplary embodiment, the belt retraction spool and the driven element of the one-way clutch may be connected in a direct transmission manner. Preferably, the driven element may be an integral composition of the belt retraction spool.

The technical features already mentioned above, those to be mentioned below and those shown in the accompanying drawings can be combined with one another as desired, as long as the combined technical features are not mutually inconsistent. All possible combinations of features are technical contents contained in the present application.

According to an exemplary embodiment as shown schematically in FIGS. 2, 3A-3C, 4, 5, 6, 7, 8A, 8B, 9 and 10, a seatbelt retractor RT may comprise a belt retraction spool 1, a driving device 4 and a one-way clutch 10. The driving device may be connected with a driving element shown as drive gear 11 of the one-way clutch in a transmission manner, and the belt retraction spool may be connected with a driven element shown as driven gear 12 of the one-way clutch in a transmission manner. The driving element may be configured to rotate in a first direction D and a second direction R opposite to the first direction. The driven element may have a common rotation axis 3 with the driving element. The one-way clutch may comprise pawls 13 pivotably mounted on the driving element, a stop ring 15, and a friction ring 14 frictionally coupled with the stop ring. The driving element may be configured to rotate relative to the friction ring between a first rotational position and a second rotational position downstream of the first rotational position in the first direction. In the first rotational position, the pawls may be in a first pivot position relative to the driving element, and in the first pivot position, the pawls may be disengaged from the driven element. In the second rotational position, the pawls may be in a second pivot position relative to the driving element pivoted radially inward from the first pivot position, and in the second pivot position, the pawls may be engaged with the driven element. Each pawl may comprise a locking component 35 configured to lock with the driving element in a pass-through position for the pawl passing through the first pivot position in a radially-outward pivot direction when the pawl passes through the first pivot position in the radially-outward pivot direction. The locking components may comprise elastic components, and in the first pivot position, the pawls may abut against the driving element through the locking components. Each locking component may comprise a hook portion 36 configured to be hooked by the driving element when the pawl passes through the first pivot position in the radially-outward pivot direction, such that the pawl is held in the pass-through position. The driving element may comprise projections 112 comprising engaging hook portions 117. Each pawl may abut against a surface of the projection adjacent to the engaging hook portion through the hook portion in the first pivot position, and the hook portion may slide on the projection when the pawl pivots relative to the driving element from the first pivot position towards the pass-through position, such that the hook portion may hook the engaging hook portion. The locking components may be injection-molded onto bodies of the pawls. The locking components may protrude from bodies of the pawls in a direction away from the free end portions of the pawls. Each pawl may comprise a free end portion 32 remote from a pivot axis parallel to the rotation axis. The free end portion may be configured for cooperation with the driven element. Each pawl may comprise a sliding surface 33. The friction ring may comprise guiding members 141, 142 configured to guide the sliding surfaces. The pawls may be configured to pivot relative to the driving element between the first pivot position and the second pivot position through cooperation of the guiding members and the sliding surfaces when the driving element rotates relative to the friction ring between the first rotational position and the second rotational position. The sliding surfaces may protrude axially from bodies 31 of the pawls with reference to the pivot axes of the pawls. The one-way clutch may comprise two pawls, and the pivot axes of the two pawls may be on one diameter line with reference to the rotation axis. The friction ring may comprise a pair of guiding members configured to guide the sliding surfaces on both sides of the sliding surfaces. The pair of guiding members may comprise contact portions opposite to each other, and the sliding surfaces may be guided between the contact portions. Each contact portion may comprise a cylindrical surface. Each first guiding member 141 of the pair of guiding members may comprise a first portion 41 protruding inwardly from a ring body of the friction ring, a second portion 42 bent relative to the first portion at a radially inner end portion of the first portion, and a third portion 43 protruding axially from the second portion, the third portion, as the contact portion, configured as a cylindrical body comprising a cylindrical surface. Each second guiding member 142 of the pair of guiding members may comprise an arm protruding inwardly from the ring body of the friction ring, and a free end portion 44 of the arm, as the contact portion, comprising a cylindrical surface. The third portion may be radially inward of the free end portion of the arm with reference to the rotation axis. The third portion and the free end portion of the arm may have the same angular position in a circumferential direction or may have an angular spacing. The friction ring may be mounted radially inward of the stop ring. An outer circumferential surface of the friction ring may be frictionally coupled with an inner circumferential surface of the stop ring. The driving element and the friction ring may each comprise a first cam 114, 144. The first cams may be configured for defining the first rotational position where the driving element and the friction ring are relative to each other. The driving element and the friction ring may each comprise a second cam 115, 145. The second cams may be configured to define the second rotational position where the driving element and the friction ring are relative to each other. A contact surface of the first cam of the driving element and the first cam of the friction ring may deviate from a radial plane with reference to the rotation axis. The stop ring may comprise a stator. The stop ring may be configured for limited rotation. The driving element may comprise a chamber comprising a bottom on one axial end side of the driving element. The chamber may be open on the other axial end side of the driving element. The stop ring, the friction ring and the pawls may be accommodated in the chamber. An axial stop disk 18 may be connected with the driving element and may be mounted on the other opened axial end side. The driven element may be configured to enter the chamber by passing through an opening 116 of the bottom. Portions of the pawls from the pivot axes to the free end portions may occupy an angular area of not more than 60 degrees in the first pivot position and/or in the second pivot position with reference to the rotation axis. Each pawl may comprise a locking component 35 configured to lock with the driving element in a pass-through position for the pawl passing through the first pivot position in a radially-outward pivot direction when the pawl passes through the first pivot position in the radially-outward pivot direction. The locking components may comprise elastic components. In the first pivot position, the pawls may abut against the driving element through the locking components. Each locking component may comprise a hook portion 36 configured to be hooked by the driving element when the pawl passes through the first pivot position in the radially-outward pivot direction, such that the pawl is held in the pass-through position. The locking components may be injection molded onto bodies of the pawls. The locking components may protrude from bodies of the pawls in a direction away from the free end portions of the pawls. The driving element may comprise projections 112 comprising engaging hook portions 117. Each pawl may abut against a surface of the projection adjacent to the engaging hook portion through the hook portion in the first pivot position. The hook portion may slide on the projection when the pawl pivots relative to the driving element from the first pivot position towards the pass-through position such that the hook portion hooks the engaging hook portion. The friction ring may comprise elastic components 146 configured to press the pawls and counteract the pawls leaving the first pivot position in a radially-inward pivot direction in the first pivot position of the pawls relative to the driving element. The elastic components of the friction ring may be out of contact with the pawls upon a predetermined stroke of the pawls away from the first pivot position in the radially-inward pivot direction. The elastic components of the friction ring may comprise finger-shaped elements injection-molded onto a ring body of the friction ring. The driving element and the driven element may comprise gears.

### Exemplary Embodiments—C

Among vehicles, especially passenger cars, the seatbelt can be an effective and reliable passive safety device and is a mandatory configuration in a safety system of a whole vehicle. Under the development trend of electric and intelligent vehicles, the requirements of seatbelts on safety protection and wearing comfort of occupants have become higher.

Some seatbelts known in practice comprise irreversible pre-tensioning devices comprising a pyrotechnic gas generator, a coil pipe and a steel ball, a flexible rack or the like accommodated in the coil pipe. When an emergency situation of a vehicle is about to occur, for example, when a vehicle collision is about to occur, a vehicle control unit can send out a control instruction, such that the pyrotechnic gas generator is activated, the powder is ignited, the steel ball, the flexible rack or the like moves out of the coil pipe under the action of the explosive force, and the belt retraction spool of the seatbelt retractor is driven in the webbing belt retraction direction, such that the webbing belt is retracted, and therefore a gap inside the seatbelt retractor and a gap between the webbing belt and the body of an occupant are eliminated. As a result, the occupant can be better restrained on a vehicle seat, and the occupant can be well protected by the seatbelt in the emergency situation of the vehicle.

In addition, some seatbelts known in practice may further comprise, in addition to the irreversible pre-tensioning devices, reversible active pre-tensioning devices. The active pre-tensioning device may typically comprise a reversible electric motor, an electronic control unit for controlling the operation of the electric motor, a transmission device and a one-way clutch. In the course of operation of the vehicle, in certain dangerous situations or when it is necessary to warn the occupant, the reversible electric motor can be activated according to a predetermined control logic, such that the reversible electric motor drives the belt retraction spool of the seatbelt retractor in the webbing belt retraction direction via the transmission device and the engaged one-way clutch, so as to actively pretension the webbing belt to a suitable extent. The reversible electric motor is then reversed, for example after the dangerous situations are eliminated or after a predetermined long time has elapsed, and then the active pre-tensioning of the webbing belt is deactivated. The electronic control unit may, for example, acquire a control instruction from the vehicle control unit. When the active pre-tensioning device is triggered, the one-way clutch in the transmission path between the reversible electric motor and the belt retraction spool is taken as a force bearing component and also plays a role in outputting the torque from the reversible electric motor. The one-way clutch is preferably completely decoupled from other various functions of a conventional seatbelt retractor when the active pre-tensioning function is deactivated, at least substantially, in particular completely, without interfering with the other functions of the seatbelt retractor. For example, in the event of an unavoidable imminent collision, the irreversible pre-tensioning device is activated, the powder of a pyrotechnic gas generator is ignited, and at the moment, the activated active pre-tensioning device preferably does not interfere with this irreversible pre-tensioning function.

A one-way clutch for a seatbelt retractor may comprise a driving element, a driven element, pawls, a stop ring and a friction ring. The driving member may rotatable relative to the friction ring between a first rotational position and a second rotational position. The pawls may be in a first pivot position relative to the driving element and may be disengaged from the driven element in the first rotational position. The pawls may be in a second pivot position radially inward from the first pivot position relative to the driving element and may be engaged with the driven element in the second rotational position. Each pawl may comprise a sliding surface. The friction ring may comprise guiding members configured to guide the sliding surfaces on both sides of the sliding surfaces. The pawls may pivot relative to the driving element between the first pivot position and the second pivot position through cooperation of the guiding members and the sliding surfaces when the driving element rotates relative to the friction ring between the first rotational position and the second rotational position.

A one-way clutch for a seatbelt retractor may comprise a driving element, a driven element, pawls, a stop ring and a friction ring. The driving member may be configured to rotate relative to the friction ring between a first rotational position and a second rotational position. The pawls may be in a first pivot position relative to the driving element and may be disengaged from the driven element in the first rotational position. The pawls may be in a second pivot position radially inward from the first pivot position relative to the driving element and may be engaged with the driven element in the second rotational position. Each pawl may comprise a locking component locking with the driving element in a pass-through position when the pawl passes through the first pivot position in the radially outward pivot direction. The one-way clutch may be switched and held in the inoperative state when the irreversible pre-tensioning device is activated without the irreversible pre-tensioning function being impaired.

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

1. A seatbelt retractor for a vehicle interior comprising:
(a) a belt;
(b) a belt retraction spool configured to pretension the belt;
(c) a motor;
(d) a transmission coupled to the motor; and
(e) a one-way clutch coupled to the transmission;
wherein the one-way clutch is configured for a disengaged state and an engaged state to pretension the belt;
wherein when the one-way clutch is in the engaged state, the motor is configured to drive the belt retraction spool via the transmission device and the one-way clutch to pretension the belt;
wherein the one-way clutch comprises a drive gear and a driven gear as well as a set of pawls pivotably mounted on the drive gear,
wherein the drive gear is configured to rotate in a first direction to retract the belt and a second direction opposite to the first direction,
wherein the drive gear and the driven gear comprise a common axis of rotation,
wherein the one-way clutch comprises a friction ring frictionally coupled with a stop ring,
wherein the drive gear is configured to rotate relative to the friction ring between a first rotational position and a second rotational position; wherein when the drive gear is in the first rotational position, the set of pawls is in a first pivot position disengaged from the driven gear; wherein when the drive gear is in the second rotational position, the pawls are in a second pivot position engaged with the driven gear,
wherein each pawl of the set of pawls comprises a locking component configured to lock with the drive gear.

2.-8. (canceled)

9. The seatbelt retractor of claim 1, wherein the locking component is injection-molded onto a body of the pawl.

10. The seatbelt retractor of claim 1, wherein the locking component is configured to protrude from a body of a pawl of the set of pawls in a direction away from a free end portion of the pawl.

11. The seatbelt retractor of claim 1, wherein each pawl of the set of pawls comprises a free end portion remote from a pivot axis parallel to the rotation axis; wherein the free end portion is configured for cooperation with the driven gear.

12. The seatbelt retractor of claim 1, wherein the locking component comprises an elastic component; wherein a pawl of the set of pawls is configured to abut against the drive gear through the locking component.

13. The seatbelt retractor of claim 12, wherein the locking component comprises a hook portion configured to be hooked by the drive gear.

14. The seatbelt retractor of claim 13, wherein the drive gear comprises a projection comprising an engaging hook portion; wherein a pawl of the set of pawls is configured to abut against a surface of the projection of the drive gear adjacent to the engaging hook portion through the hook portion in the first pivot position; wherein the hook portion is configured to slide on the projection to hook the engaging hook portion.

15. (canceled)

16. A seatbelt retractor for a vehicle interior comprising:
(a) a belt;
(b) a belt retraction spool configured to pretension the belt;
(c) a motor;
(d) a transmission coupled to the motor; and
(c) a one-way clutch coupled to the transmission;
wherein the one-way clutch is configured for a disengaged state and an engaged state to pretension the belt;
wherein when the one-way clutch is in the engaged state, the motor is configured to drive the belt retraction spool via the transmission device and the one-way clutch to pretension the belt;
wherein the one-way clutch comprises a drive gear and a driven gear as well as a set of pawls pivotably mounted on the drive gear,
wherein the drive gear is configured to rotate in a first direction to retract the belt and a second direction opposite to the first direction,
wherein the drive gear and the driven gear comprise a common axis of rotation,
wherein the one-way clutch comprises a friction ring frictionally coupled with a stop ring,
wherein the drive gear is configured to rotate relative to the friction ring between a first rotational position and a second rotational position; wherein when the drive gear is in the first rotational position, the set of pawls is in a first pivot position disengaged from the driven gear; wherein when the drive gear is in the second rotational position, the pawls are in a second pivot position engaged with the driven gear,
wherein a pawl of the set of pawls comprises a sliding surface; wherein the friction ring comprises a guiding member configured to guide the sliding surface.

17. The seatbelt retractor of claim 16, wherein when the drive gear rotates relative to the friction ring between the first rotational position and the second rotational position, the pawl is configured to pivot relative to the drive gear between the first pivot position and the second pivot position through cooperation of the guiding member and the sliding surface.

18. The seatbelt retractor of claim 16, wherein each pawl comprises a free end portion adjacent the sliding surface; wherein the free end portion is configured for cooperation with the driven gear.

19. The seatbelt retractor of claim 16, wherein the sliding surface protrudes axially from a body of a pawl of the set of pawls.

20. (canceled)

21. The seatbelt retractor of claim 16, wherein the pawls each comprise a sliding surface; wherein the friction ring comprises a pair of guiding members configured to guide the sliding surface on two sides of the sliding surface; wherein the pair of guiding members comprise contact portions opposite to each other; wherein the sliding surface is guided between the contact portions.

22. (canceled)

23. The seatbelt retractor of claim 21, wherein a first guiding member of the pair of guiding members comprises a first portion protruding inwardly from a ring body of the friction ring, a second portion bent relative to the first portion at a radially inner end portion of the first portion, and a third portion protruding axially from the second portion; wherein the third portion comprises a cylindrical body comprising a cylindrical surface.

24. The seatbelt retractor of claim 23, wherein a second guiding member of the pair of guiding members comprises an arm protruding inwardly from the ring body of the friction ring, and a free end portion of the arm, as the contact portion, comprises a cylindrical surface.

25. The seatbelt retractor of claim 24, wherein the third portion is radially inward of the free end portion of the arm with reference to the rotation axis, and/or the third portion and the free end portion of the arm have the same angular position in a circumferential direction or have an angular spacing.

26. The seatbelt retractor of claim 17, wherein the friction ring is mounted radially inward of the stop ring; wherein an outer circumferential surface of the friction ring is frictionally coupled with an inner circumferential surface of the stop ring.

27. The seatbelt retractor of claim 17, wherein the drive gear and the friction ring each comprise at least one of:
a first cam; wherein the first cam of the drive gear and the first cam of the friction ring are configured to define the first rotational position; and
a second cam, wherein the second cam of the drive gear and the second cam of the friction ring are configured to define the second rotational position.

28.-30. (canceled)

31. The seatbelt retractor of claim 17, wherein the drive gear comprises a chamber comprising a bottom on one axial end side of the drive gear; wherein the chamber is open on the other axial end side of the drive gear; wherein the stop ring, the friction ring and the pawls are accommodated in the chamber; wherein an axial stop disk connected with the drive gear is mounted on the other opened axial end side, and the driven gear is configured to enter the chamber by passing through an opening of the bottom.

32. (canceled)

33. The seatbelt retractor of claim 17, wherein each pawl of the set of pawls comprises a locking component configured to lock with the drive gear in a pass-through position for the pawl passing through the first pivot position in a radially-outward pivot direction when the pawl passes through the first pivot position in the radially-outward pivot direction, wherein the locking component is injection-molded onto a body of a pawl of the set of pawls, wherein the locking component protrudes from a body of a pawl of the set of pawls in a direction away from a free end portion of the pawl.

34. The seatbelt retractor of claim 33, wherein the locking component comprises at least one of:
an elastic component, wherein in the first pivot position, a pawl of the set of pawls abut against the drive gear through the locking component; and
a hook portion configured to be hooked by the drive gear when the pawl passes through the first pivot position in the radially-outward pivot direction, such that the pawl is held in the pass-through position.

35. (canceled)

36. The seatbelt retractor of claim 34, wherein the drive gear comprises projections comprising engaging hook portions; wherein each pawl of the set of pawls abuts against a surface of a projection adjacent to the engaging hook portion through the hook portion in the first pivot position; wherein the hook portion is configured to slide on the projection when the pawl pivots relative to the drive gear from the first pivot position towards the pass-through position, such that the hook portion hooks the engaging hook portion.

37-38. (canceled)

39. The seatbelt retractor of claim 17, wherein the friction ring comprises elastic components; wherein the elastic components of the friction ring are configured to press the set of pawls and counteract the set of pawls leaving the first pivot position in a radially-inward pivot direction in the first pivot position of the set of pawls relative to the drive gear,
wherein the elastic components of the friction ring are out of contact with the set of pawls upon a predetermined stroke of the set of pawls away from the first pivot position in the radially-inward pivot direction,
wherein the elastic components of the friction ring are finger-shaped elements injection-molded onto a ring body of the friction ring.

40.-42. (canceled)

43. A one-way clutch, comprising:
a driving element rotatable in a first direction and a second direction opposite to the first direction;
a driven element having a common rotation axis with the driving element;
pawls pivotably mounted on the driving element;
a stop ring; and
a friction ring frictionally coupled with the stop ring;
wherein the driving element is rotatable relative to the friction ring between a first rotational position and a second rotational position downstream of the first rotational position in the first direction, wherein in the first rotational position, the pawls are in a first pivot position relative to the driving element, and in the first pivot position, the pawls are disengaged from the driven element; in the second rotational position, the pawls are in a second pivot position relative to the driving element pivoted radially inward from the first pivot position, and in the second pivot position, the pawls are engaged with the driven element;
wherein each pawl has a sliding surface, the friction ring has guiding members for guiding the sliding surfaces on both sides of the sliding surfaces, and the pawls are pivotable relative to the driving element between the first pivot position and the second pivot position through cooperation of the guiding members and the sliding surfaces when the driving element rotates relative to the friction ring between the first rotational position and the second rotational position.

44. The one-way clutch of claim 43, wherein each pawl has a free end portion remote from a pivot axis parallel to the rotation axis, the free end portion being configured for cooperation with the driven element.

45. The one-way clutch of claim 43, wherein the sliding surfaces protrude axially from bodies of the pawls with reference to the pivot axes of the pawls.

46. (canceled)

47. The one-way clutch of claim 43, wherein the friction ring has a pair of guiding members for guiding the sliding surfaces on both sides of the sliding surfaces, the pair of guiding members have contact portions opposite to each other, and the sliding surfaces are guided between the contact portions.

48. (canceled)

49. The one-way clutch of claim 47, wherein each first guiding member of the pair of guiding members comprises a first portion protruding inwardly from a ring body of the friction ring, a second portion bent relative to the first portion at a radially inner end portion of the first portion, and a third portion protruding axially from the second portion, the third portion, as the contact portion, being configured as a cylindrical body having a cylindrical surface; and/or each second guiding member of the pair of guiding members comprises an arm protruding inwardly from the ring body of the friction ring, and a free end portion of the arm, as the contact portion, has a cylindrical surface,
wherein the third portion is radially inward of the free end portion of the arm with reference to the rotation axis, and/or the third portion and the free end portion of the arm have the same angular position in a circumferential direction or have an angular spacing.

50. (canceled)

51. The one-way clutch of claim 43, wherein the friction ring is mounted radially inward of the stop ring, and wherein an outer circumferential surface of the friction ring is frictionally coupled with an inner circumferential surface of the stop ring.

52.-56. (canceled)

57. The one-way clutch of claim 43, wherein each pawl has a locking component configured to lock with the driving element in a pass-through position for the pawl passing through the first pivot position in a radially-outward pivot direction when the pawl passes through the first pivot position in the radially-outward pivot direction.

58. The one-way clutch of claim 57, wherein the locking components are elastic components, and in the first pivot position, the pawls abut against the driving element through the locking components,
wherein each locking component has a hook portion configured to be hooked by the driving element when the pawl passes through the first pivot position in the radially-outward pivot direction, such that the pawl is held in the pass-through position,
wherein the locking components protrude from bodies of the pawls in a direction away from the free end portions of the pawls.

59-61. (canceled)

62. The one-way clutch of claim 58, wherein the driving element has projections having engaging hook portions, wherein each pawl abuts against a surface of the projection adjacent to the engaging hook portion through the hook portion in the first pivot position, and the hook portion slides on the projection when the pawl pivots relative to the driving element from the first pivot position towards the pass-through position, such that the hook portion hooks the engaging hook portion.

63-66. (canceled)

67. A seatbelt retractor comprising a belt retraction spool, a driving device and the one-way clutch of claim 43, wherein the driving device is connected with a driving element of the one-way clutch in a transmission manner, and the belt retraction spool is connected with a driven element of the one-way clutch in a transmission manner.

68. A one-way clutch comprising:
a driving element rotatable in a first direction and a second direction opposite to the first direction;
a driven element having a common rotation axis with the driving element;
pawls pivotably mounted on the driving element;
a stop ring; and
a friction ring frictionally coupled with the stop ring;
wherein the driving element is rotatable relative to the friction ring between a first rotational position and a second rotational position downstream of the first rotational position in the first direction, wherein in the first rotational position, the pawls are in a first pivot position relative to the driving element, and in the first pivot position, the pawls are disengaged from the driven element; in the second rotational position, the pawls are in a second pivot position relative to the driving element pivoted radially inward from the first pivot position, and in the second pivot position, the pawls are engaged with the driven element;
wherein, each pawl has a locking component configured to lock with the driving element in a pass-through position for the pawl passing through the first pivot position in a radially-outward pivot direction when the pawl passes through the first pivot position in the radially-outward pivot direction.

69. The one-way clutch of claim 68, wherein the locking components each comprise at least one of:
an elastic component, wherein in the first pivot position, the pawls abut against the driving element through the locking components, and
a hook portion configured to be hooked by the driving element when the pawl passes through the first pivot position in the radially-outward pivot direction, such that the pawl is held in the pass-through position.

70. (canceled)

71. The one-way clutch of claim 69, wherein the driving element comprises projections having engaging hook portions, wherein each pawl abuts against a surface of the projection adjacent to the engaging hook portion through the hook portion in the first pivot position, and the hook portion is configured to slide on the projection when the pawl pivots relative to the driving element from the first pivot position towards the pass-through position, such that the hook portion hooks the engaging hook portion.

72.-74. (canceled)
